(19) United States
(12) Patent Application Publication
(10) Pub. No.: US 2015/0108213 A1
(43) Pub. Date: Apr. 23, 2015

(54) SHOPPING SUPPORT DEVICE AND SHOPPING SUPPORT METHOD

(71) Applicant: TOSHIBA TEC KABUSHIKI KAISHA, Tokyo (JP)

(72) Inventors: Yasutsugu SASAKI, Ohta Tokyo (JP); Kanya HIROI, Yokohama Kanagawa (JP); Mahina NAKAMURA, Musashino Tokyo (JP); Maki SATO, Yokohama Kanagawa (JP); Yumiko OKUMA, Nakano Tokyo (JP); Masayuki NAKAEDA, Kawasaki Kanagawa (JP)

(21) Appl. No.: 14/518,877

(22) Filed: Oct. 20, 2014

(30) Foreign Application Priority Data
Oct. 23, 2013 (JP) 2013-220622

(51) Int. Cl. G06Q 30/06

(52) U.S. Cl. CPC G06Q 30/0641; G06Q 30/0633
USPC 235/383

(57) ABSTRACT

According to an embodiment, a shopping support device has a controller which acquires identification information of a commodity from an electronic shelf tag using a communication unit. The controller acquires commodity information corresponding to the identification information, makes a storage unit store the commodity information, and makes a display display the commodity information.

### CROSS-REFERENCE TO RELATED APPLICATION

This application is based upon and claims the benefit of priority from Japanese Patent Application No. 2013-220622, filed on Oct. 23, 2013, the entire contents of which are incorporated herein by reference.

### FIELD

Embodiments described herein relate generally to a shopping support device and a shopping support method.

### BACKGROUND

Conventionally, a POS (Point Of Sales) terminal to convert a purchase history such as a receipt into electronic data has been proposed. Furthermore, a system to provide the above-described electronized purchase history information to a portable terminal and so on of a customer has been proposed. Furthermore, a shopping list creation device to create a shopping list using a commodity name included in the purchase history information has been proposed.

Furthermore, recently, a touch panel display, and a portable terminal equipped with an NFC (Near Field Communication) function and so on are spreading. A user (customer) performs shopping in a store, while making a shopping list to be displayed in these portable terminals.

However, since the portable terminal equipped with the above-described conventional technology only displays the shopping list, the portable terminal lacks in convenience for the customer, and there is further room for improvement in the point of shopping support.

### BRIEF DESCRIPTION OF THE DRAWINGS

FIG. 1 is a diagram showing a shopping support system including a shopping support device according to a first embodiment.

FIG. 2 is a block diagram showing the customer terminal that is the shopping support device according to the first embodiment.

FIG. 3 is a diagram showing the commodity reference table of the shopping support device according to the first embodiment.

FIG. 4 is a block diagram showing the center server of the shopping support system including the shopping support device according to the first embodiment.

FIG. 5 is a diagram showing a shopping list management table of the center server of the shopping support system including the shopping support device according to the first embodiment.

FIG. 6 is a diagram showing a first purchase history management table of the center server of the shopping support system including the shopping support device according to the first embodiment.

FIG. 7 is a block diagram showing the store server of the shopping support system including the shopping support device according to the first embodiment.

FIG. 8 is a diagram showing the commodity management table of the store server of the shopping support system including the shopping support device according to the first embodiment.

FIG. 9 is a diagram showing the purchase commodity management table of the store server of the shopping support system including the shopping support device according to the first embodiment.

FIG. 10 is a block diagram showing the POS terminal of the shopping support system including the shopping support device according to the first embodiment.

FIG. 11 is a block diagram showing the electronic shelf tag of the shopping support system including the shopping support device according to the first embodiment.

FIG. 12 is a block diagram showing the commodity identification information storage table of the electronic shelf tag of the shopping support system including the shopping support device according to the first embodiment.

FIG. 13 is a flow chart showing a first creation support processing which the shopping support system including the shopping support device according to the first embodiment executes.

FIG. 14 is a diagram showing an example of a shopping guide screen which the customer terminal that is the shopping support device according to the first embodiment displays.

FIG. 15 is a diagram showing an example of the shopping guide screen which the customer terminal that is the shopping support device according to the first embodiment displays.

FIG. 16 is a flow chart showing a shopping support processing which the shopping support system including the shopping support device according to the first embodiment executes.

FIG. 17 is a diagram showing an example of a privilege imparting screen which the customer terminal that is the shopping support device according to the first embodiment displays.

FIG. 18 is a diagram showing an example of a shopping support screen which the customer terminal that is the shopping support device according to the first embodiment displays.

FIG. 19 is a flow chart showing a commodity selection support processing which the customer terminal that is the shopping support device according to the first embodiment executes.

FIG. 20 is a diagram showing an example of a commodity information screen which the customer terminal that is the shopping support device according to the first embodiment displays.

FIG. 21 is a diagram showing an example of a recipe list screen which the customer terminal that is the shopping support device according to the first embodiment displays.

FIG. 22 is a diagram showing an example of the shopping support screen added with a recommended commodity which the customer terminal that is the shopping support device according to the first embodiment displays.

FIG. 23 is a diagram showing an example of a history list screen which the customer terminal that is the shopping support device according to the first embodiment displays.

FIG. 24 is a flow chart showing a commodity sales data processing which the POS terminal of the shopping support system including the shopping support device according to the first embodiment executes.

### DETAILED DESCRIPTION

According to an embodiment, a shopping support device has a communication unit, a storage unit, a display, and a controller. The communication unit communicates with an electronic shelf tag on which a price of a commodity is displayed, so as to read identification information of the displayed commodity from the electronic shelf tag. The storage unit stores the identification information and commodity information of the commodity corresponding to each other. The display displays the commodity information stored in the storage unit. The controller acquires the commodity information of the commodity corresponding to the identification information which is read using the communication unit, makes the storage unit store the acquired commodity information corresponding to the identification information, and makes the display display the commodity information stored in the storage unit.

Hereinafter, a shopping support device according to a first embodiment will be described with reference to the drawings. In the drawings, the same symbols show the same or similar portions. The embodiment is not limited to the following description.

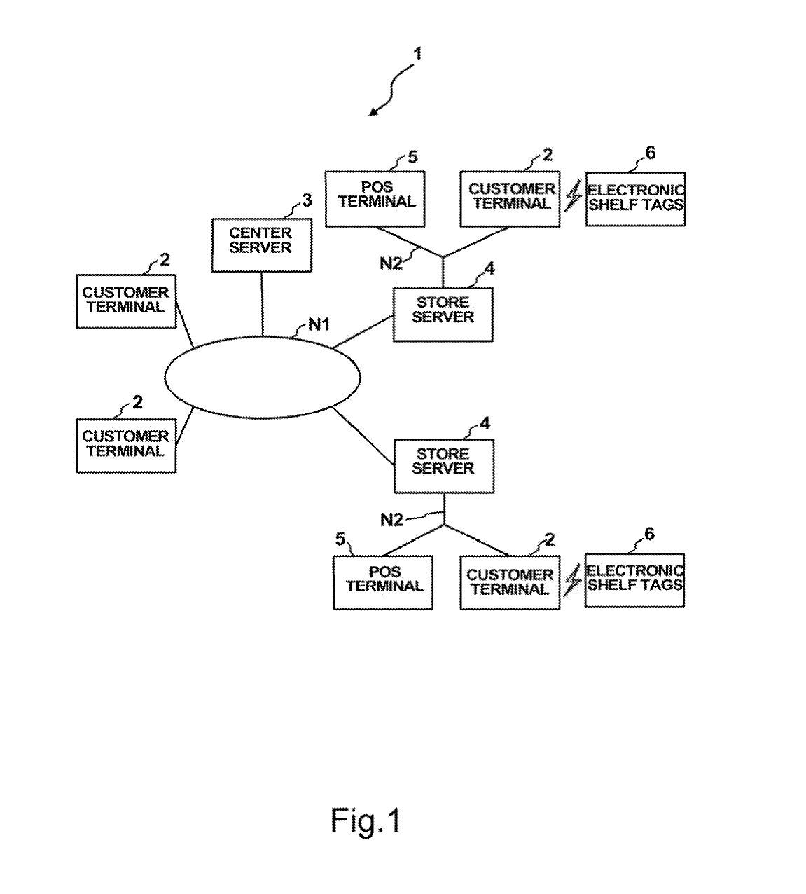

A whole configuration of a shopping support system including a shopping support device according to a first embodiment will be described with reference to FIG. 1. FIG. 1 is a diagram showing a shopping support system 1 according to a first embodiment. The shopping support system 1 has customer terminals 2 that are shopping support devices, a center server 3, store servers 4, POS terminals 5, electronic shelf tags 6. The customer terminal 2, the store server 4, and the center server 3 connect to each other via a network N1 such as a public line or Internet. Accordingly, the customer terminal 2, the store server 4, and the center server 3 can communicate with each other via the network N1. The store server 4, the POS terminal 5, the customer terminal 2 connect to each other via a network N2 such as a LAN provided in a store. Accordingly, the store server 4, the POS terminal 5, the customer terminal 2 can communicate with each other via the network N2. Furthermore, the customer terminal 2 and the electronic shelf tag 6 can communicate with each other via an NFC. The numbers of the customer terminals 2, the store servers 4, the POS terminals 5 and the electronic shelf tags 6 are not limited to the numbers of the example of FIG. 1, respectively.

The customer terminal 2 that is the shopping support device is an information processing unit such as a tablet terminal and a smartphone which an operator operates. In the following description, an operator of the customer terminal 2, and a store user who purchases a commodity in a store, for example, are generally called customers. The customer terminal 2 cooperates with the center server 3 and so on, to support creation of a shopping list by a customer. The shopping list is a list in which a commodity of a purchase candidate of a customer (hereinafter, called a candidate commodity) is recorded, for example. Specifically, the shopping list is a list of the candidate commodity inputted by a customer, according to an input mode described later. Furthermore, the customer terminal 2 cooperates with the store server 4 and so on, to support the shopping of the candidate commodity by a customer based on the shopping list.

The center server 3 is a server device installed in a data center, for example. The center server 3 stores various data relating to a customer and a store, in order to manage the various data relating to the customer and the store. Furthermore, the center sever 3 mediates information exchange between the customer terminal 2 and the store server 4. The number of stores (store servers 4) connected to the center server 3 is not limited.

The store server 4 is a server device which is installed in each store. The store server 4 executes analysis processing relating to sales management and sales strategy of commodities sold in the store. In the following description, a commodity sold in a store is simply called a sales commodity. Furthermore, the store server 4 provides various information such as an electronic coupon and an advertisement, relating to the above-described candidate commodity or the above-described sales commodity to the customer terminal 2, through the center server 3 and so on.

The POS terminal 5 is a commodity sales data processing unit which is installed in a store of each store. The POS terminal 5 accepts an operation by an employee of the store. The POS terminal 5 accepts the operation by the employee of the store, to accept a sales input of a sales commodity which a customer purchases. The POS terminal 5 accepts the sales input, to perform sales registration of the sales commodity which the customer purchases. The POS terminal 5 outputs purchase history information including transaction content of the registered sales. The number of the POS terminals 5 installed in each store is not limited.

The electronic shelf tag 6 is a shelf tag which displays a name of a commodity (commodity name), a price of the commodity, and so on. The electronic shelf tag 6 has an RFID (Radio Frequency Identification) tag. The RFID tag stores commodity information described later of the above displayed commodity.

Hereinafter, configurations of the above-described respective devices included in the shopping support system 1 will be described.

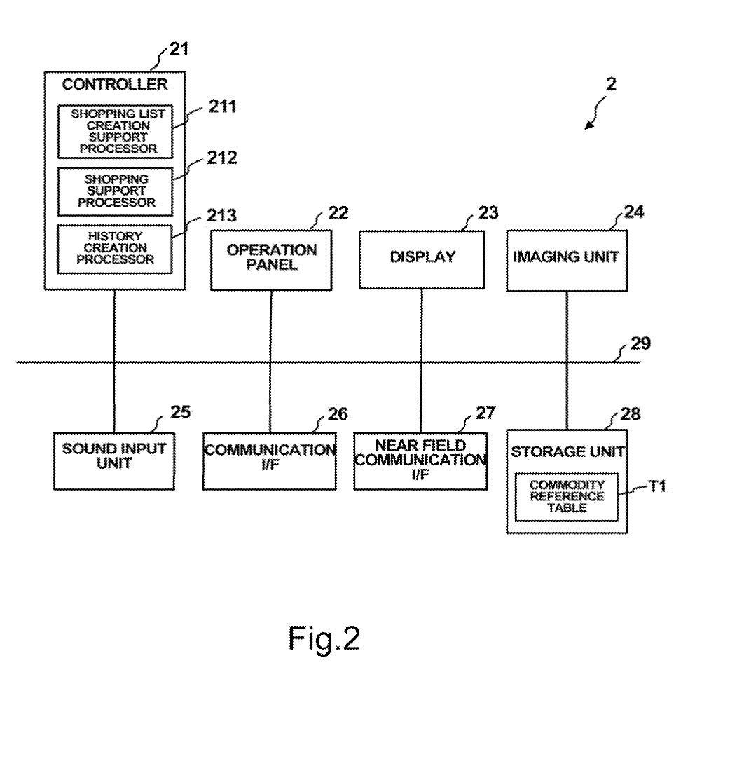

A configuration of the customer terminal 2 will be described with reference to FIG. 2. FIG. 2 is a block diagram showing the customer terminal 2. As shown in FIG. 2, the customer terminal 2 has a controller 21. The controller 21 executes various calculations, and integrated control of the respective units of the customer terminal 2. The controller 21 is a computer including a CPU (Central Processing Unit), a RAM (Random Access Memory), a ROM (Read Only Memory), and an RTC (Real Time Clock) unit, and so on. The RAM is a main storage device of the controller 21. The ROM stores various programs and data. The RTC unit clocks current date and time.

The customer terminal 2 further has an operation panel 22 and a display 23. The operation panel 22 and the display 23 connect to the controller 21 via a bus 29. The operation panel 22 has an operation key and an operation button, for example, to accept an operation input by a customer. The display 23 is a liquid crystal display, for example. The display 23 displays various information such as a name of a candidate commodity. The display 23 is a display of a touch panel type, and functions also as the operation panel 22.

The customer terminal 2 further has an imaging unit 24 and a sound input unit 25. The imaging unit 24 and the sound input unit 25 connect to the controller 21 via the bus 29. The imaging unit 24 has an imaging element such as a CCD (Charge Coupled Device) or a CMOS (Complementary Metal-Oxide Semiconductor). The imaging unit 24 images various photographic subjects. The imaging unit 24 images a code symbol of a candidate commodity described later, and an image of the candidate commodity, and so on, as the photographic subject, for example. The sound input unit 25 is a sound collecting device such as a microphone. The sound input unit 25 accepts an input of sound.

The customer terminal 2 further has a communication I/F (interface) 26 and a near field communication I/F 27. The communication I/F 26 and the near field communication I/F 27 connect to the controller 21 via the bus 29. The communication I/F 26 is connectable to the network N1. The communication I/F 26 is a transmission unit to transmit various information to the center server 3 and so on. Furthermore, the communication I/F 26 is a receiving unit to receive various information from the center server 3 and so on. In other words, the communication I/F doubles as the transmission unit and the receiving unit. However, the communication I/F 26 is not limited to this configuration. For example, the customer terminal 2 may have the communication I/Fs 26 separately as the transmission unit and the receiving unit. The controller 21 performs exchange of various information with the center server 3 and so on, using the communication I/F 26. The near field communication I/F 27 is a near field communication interface which is based on a standard such as NFC (Near Field Communication). The near field communication I/F 27 is a transmission unit to transmit various information to the POS terminal 5 and so on. Furthermore, the near field communication I/F 27 is a receiving unit to receive various information from the POS terminal 5 and so on. In other words, the near filed communication I/F 27 doubles as the transmission unit and the receiving unit. However, the near filed communication I/F 27 is not limited to this configuration. For example, the customer terminal 2 may have the near filed communication I/Fs 27 separately as the transmission unit and the receiving unit. The controller 21 performs exchange of various information with a device which can perform near field communication, such as the POS terminal 5 using the near field communication I/F 27.

The customer terminal 2 further has a storage unit 28. The storage unit 28 connects to the controller 21 via the bus 29. The storage unit 28 is an auxiliary storage device, such as an HDD (Hard Disk Drive) or an SSD (Solid State Drive). The storage unit 28 stores various programs which the controller 21 executes. The storage unit 28 further stores various data, such as purchase schedule information, additional information and display screen information. Furthermore, the storage unit 28 has a commodity reference table T1 so as to store reference information and so on described later.

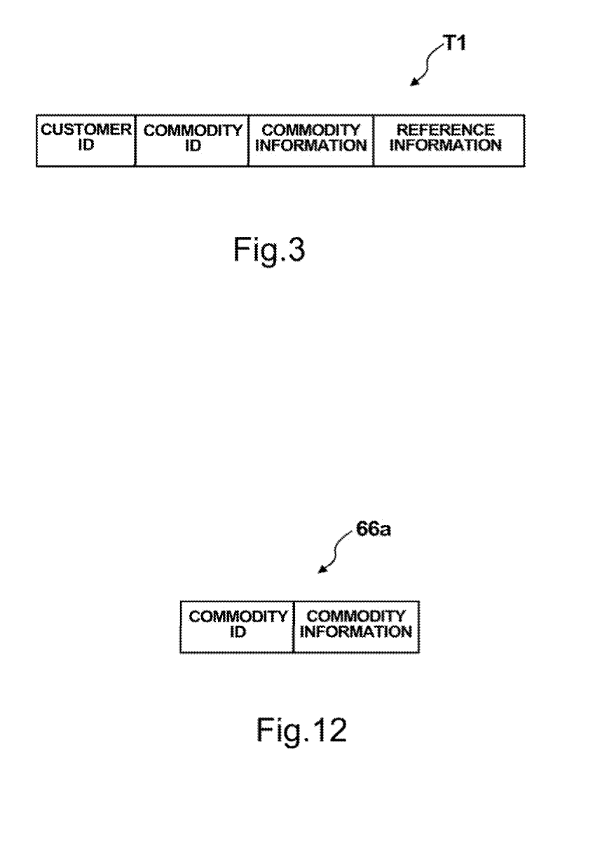

FIG. 3 is a diagram showing storage content of the commodity reference table T1. As shown in FIG. 3, the commodity reference table T1 stores a commodity ID. The commodity reference table T1 stores commodity reference information, corresponding to the customer ID. The commodity reference information includes a commodity ID, commodity information, and reference information and so on. The customer ID is identification information of a customer so as to identify each customer. The customer ID is previously assigned to a customer, after the customer takes a procedure for member registration and so on, for example. The commodity ID is identification information of the commodity which can identify each commodity. The commodity ID is a JAN code and so on, for example. The commodity information includes information of a name of the commodity (commodity name) and a unit price of the commodity. The commodity information further includes various information to be displayed in a commodity information screen G5 and a recipe list screen G6 and so on, described later. The commodity information is information obtained from the store server 4 and electronic shelf tag 6 described later. The reference information is history information that a customer has referred to the commodity information. Specifically, the reference information is the history information that a customer has browsed the commodity information, via the commodity information screen G5 and the recipe list screen G6 and so on described later. More specifically, the reference information is the history information that the display 23 has displayed the commodity information screen G5 and the recipe list screen G6 and so on described later. The reference information includes the content of the commodity information which is referred to by a customer, a referred time period and a referred time instant of, and the number of referred times. The content of the above referred commodity information is a content of the commodity information which the display 23 has displayed, such as the display contents of the commodity information screen G5 and the recipe list screen G6 and so on described later. The above referred time period and time instant are a time period and a time instant when the display 23 has displayed the commodity information in a shopping support screen G4, the commodity information screen G5 and the recipe list screen G6 and so on described later, for example. Furthermore, the above-described number of referred times is the number of times when the display has displayed the commodity information in the commodity information screen G5 and the recipe list screen G6 and so on described later, for example. The commodity reference table T1 stores the reference information for each content of the above referred commodity information. As described above, the reference information constitutes the reference history of the commodity information.

The controller 21 of the customer terminal 2 further includes a shopping list creation support processor 211, a shopping support processor 212 and a history creation processor 213, as shown in FIG. 2. The shopping list creation support processor 211, the shopping support processor 212 and the history creation processor 213 cooperate with the program stored in the ROM or the storage unit 28, to execute a processing for realizing a prescribed function. Processings which the shopping list creation support processor 211, the shopping support processor 212 and the history creation processor 213 execute will be described later.

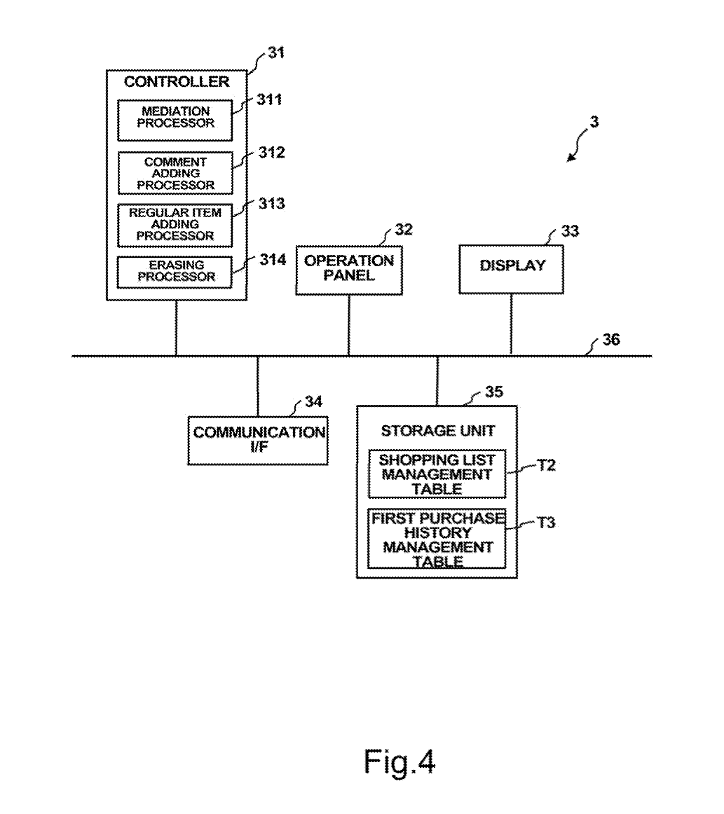

A configuration of the center server 3 will be described with reference to FIG. 4 to FIG. 6. FIG. 4 is a block diagram showing the center server 3. As shown in FIG. 4, the center server 3 has a controller 31. The controller 31 executes various calculations, and integrated control of the respective units of the center server 3. The controller 21 is a computer including a CPU, a RAM, a ROM, and an RTC unit and so on. The RAM is a main storage device of the controller 31. The ROM stores various programs and data. The RTC unit clocks current date and time.

The center server 3 further has an operation panel 32 and a display 33. The operation panel 32 and the display 33 connect to the controller 31 via a bus 36. The operation panel 32 has a key board and a pointing device, for example, to accept an operation input by an operator of the center server 3. The display 33 is a liquid crystal display, for example. The display 33 displays various information.

The center server 3 further has a communication I/F 34. The communication I/F 34 connects to the controller 31 via the bus 36. The communication I/F 34 is connectable to the network N1. The communication I/F 34 is a transmission unit to transmit various information to the customer terminal 2, the store server and so on. Furthermore, the communication I/F 34 is a receiving unit to receive various information from the customer terminal 2, the store server 4 and so on. In other words, the communication I/F 34 doubles as the transmission unit and the receiving unit. However, the communication I/F 34 is not limited to this configuration. For example, the center server 3 may have the communication I/Fs 34 separately as the transmission unit and the receiving unit. The controller 31 performs exchange of various information with the customer terminal 2, the store server 4 and so on, using the communication I/F 34.

The center server 3 further has a storage unit 35. The storage unit 35 connects to the controller 31 via the bus 36. The storage unit 35 is an auxiliary storage device, such as an HDD or an SSD. The storage unit 35 stores various programs which the controller 31 executes, and various data. The storage unit 35 further has a shopping list management table T2 and a first purchase history management table T3, in order to store data relating to a customer and a store.

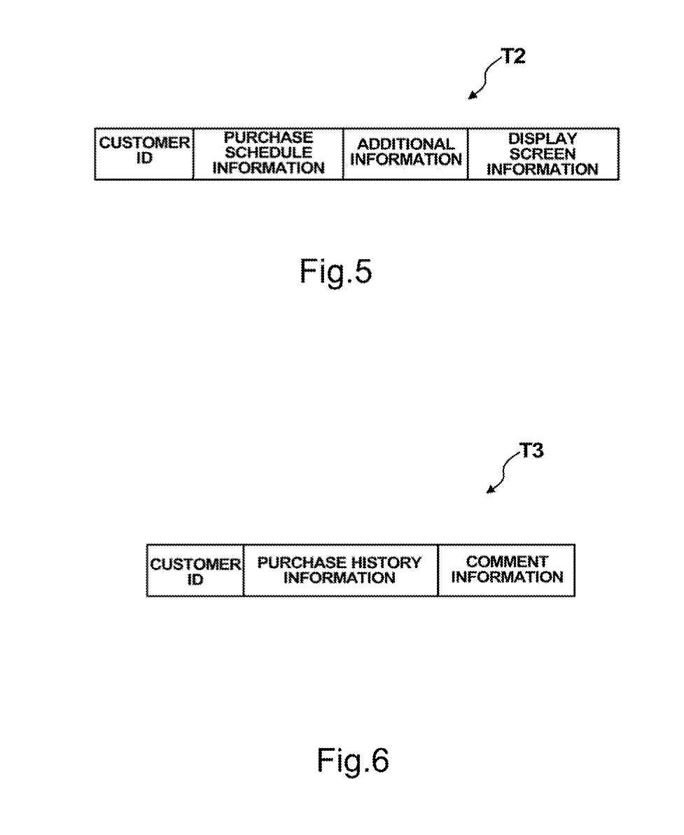

FIG. 5 is a diagram showing storage content of the shopping list management table T2. As shown in FIG. 5, the shopping list management table T2 stores a customer ID. In addition, the shopping list management table T2 stores the purchase schedule information, the additional information and the display screen information and so on, corresponding to the customer ID. As described above, the customer ID is identification information of a customer so as to identify each customer. The customer ID is previously assigned to a customer, after a customer takes a procedure for member registration and so on, for example.

The purchase schedule information includes information of a candidate commodity. The information of a candidate commodity includes a commodity name of the candidate commodity and a commodity ID of the candidate commodity, and so on. The commodity name includes a concrete name and a common name. The concrete name is a concrete name indicating a specific commodity. The common name is not a name indicating a specific commodity, but is a general name such as a classification name or a category name of a commodity. As described above, the commodity ID is identification information of a commodity capable of identifying each commodity. The commodity ID is a JAN code, for example. The additional information is information which is added to a candidate commodity included in the purchase schedule information. The additional information includes an electronic coupon instructing to impart privilege such as a discount and point imparting, and advertisement information to advertise (advertise) a specific store and commodity. When the additional information is added to a specific candidate commodity, the shopping list management table T2 stores the additional information, corresponding to the commodity ID or the commodity name of the relevant candidate commodity.

The above-described display screen information is information for realizing (reproducing) a display state of a shopping list created on a display screen of the display 23 of the customer terminal 2. The display screen information includes information relating to a display layout of the display 23, and image data such as a handwritten character described later.

FIG. 6 is a diagram showing storage content of the first purchase history management table T3. As shown in FIG. 6, the first purchase history management table T3 stores a customer ID. In addition, the first purchase history management table T3 stores the purchase history information and so on corresponding to the customer ID. The purchase history information is information indicating a history of commodities which the customer corresponding to the customer ID has purchased. In the following description, out of the above-described sales commodities, a commodity which the customer has purchased may simply be called a purchase commodity. The purchase history information includes a store ID showing a store which is a commodity purchase destination of a customer, a purchase date and time (transaction date and time) when the commodity was purchased by the customer, and information relating to each purchase commodity (a commodity name, a commodity ID, and a unit price of the commodity and so on, for example.) The store ID is identification information of a store capable of identifying each store.

Furthermore, the first purchase history management table T3 stores comment information, corresponding to the commodity ID of a purchase commodity included in the purchase history information. The comment information is various information relating to a specific commodity which is registered by an input of a customer from the customer terminal 2. The comment information includes a comment of a customer and an evaluation by a customer and so on relating to a specific commodity. The comment information is registered by the input of the customer, corresponding to the commodity ID of the specific commodity, for example.

The controller 31 of the center server 3 further includes a mediation processor 311, a comment adding processor 312, a regular item adding processor 313, and an erasing processor 314, for example, as shown in FIG. 4. Each of the processors 311-314 cooperates with a program stored in the ROM or the storage unit 35, to execute a processing for realizing a prescribed function. The processing which each of the processors 311-314 executes will be described later.

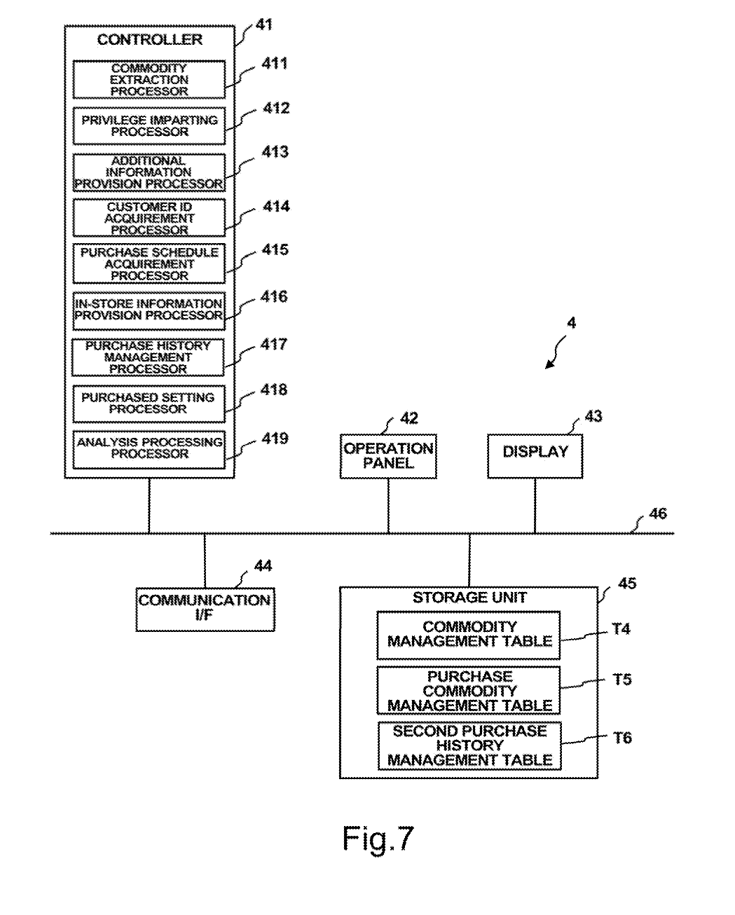

A configuration of the store server 4 will be described with reference to FIG. 7 to FIG. 9. FIG. 7 is a block diagram showing the store server 4. As shown in FIG. 7, the center server 4 has a controller 41. The controller 41 executes various calculations, and integrated control of the respective units of the store server 4. The controller 41 is a computer including a CPU, a RAM, a ROM, and an RTC unit and so on. The RAM is a main storage device of the controller 41. The ROM stores various programs and data. The RTC unit clocks current date and time.

The store server 4 further has an operation panel 42 and a display 43. The operation panel 42 and the display 43 connect to the controller 31 via a bus 46. The operation panel 2 has a key board and a pointing device, for example, to accept an operation input by an employee of the store. The display 43 is a liquid crystal display, for example. The display 43 displays various information.

The store server 4 further has a communication I/F 44. The communication I/F 44 connects to the controller 41 via the bus 46. The communication I/F 44 is connectable to the network N1 and the network N2. The communication I/F 44 is a transmission unit to transmit various information to the center server 3 and the POS terminal 5 and so on. Furthermore, the communication I/F 44 is a receiving unit to receive various information from the center server 3 and the POS terminal 5 and so on. In other words, the communication I/F 44 doubles as the transmission unit and the receiving unit. However, the communication I/F 44 is not limited to this configuration. For example, the store server 4 may have the communication I/Fs 44 separately as the transmission unit and the receiving unit. The controller 41 performs exchange of various information with the center server 3 and the POS terminal 5 and so on, using the communication I/F 44.

The store server 4 further has a storage unit 45. The storage unit 45 connects to the controller 41 via the bus 46. The storage unit 45 stores various programs which the controller 41 executes, and various data. The storage unit 55 further has a commodity management table T4, a purchase commodity management table T5, and a second purchase history management table T6.

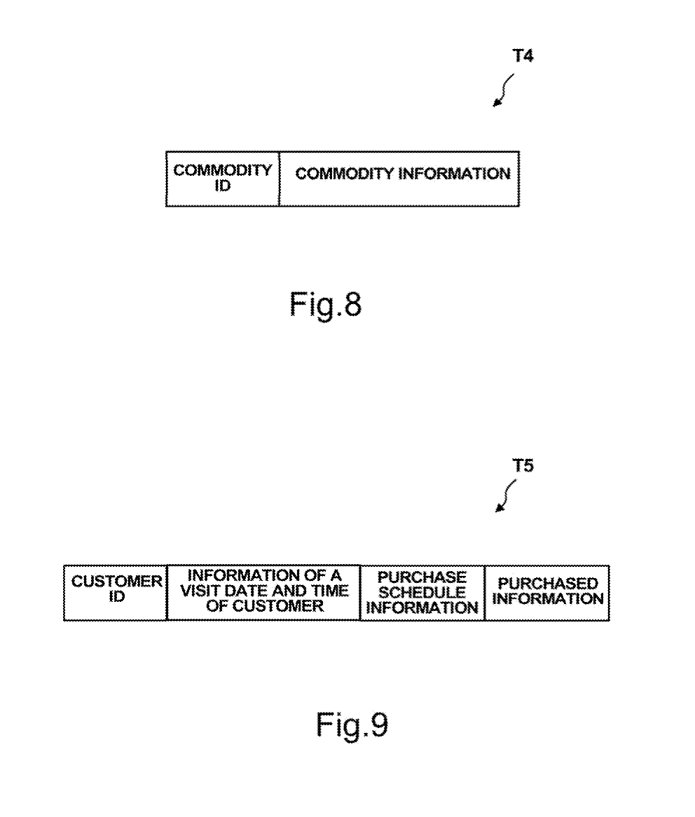

FIG. 8 is a diagram showing storage content of the commodity management table T4. As shown in FIG. 8, the commodity management table T4 stores a commodity ID of each sales commodity. Furthermore, the commodity management table T4 stores the above-described commodity information and so on of the sales commodity, corresponding to the commodity ID of each sales commodity. The commodity information of the sales commodity is information relating to a sales commodity which is sold in a store. The commodity information which the commodity management table T4 stores, includes image data such as a photograph and an illustration representing the commodity, in addition to a commodity name and a unit price of the commodity. Furthermore, as described above, the commodity information includes various information displayed in the shopping support screen G4, the commodity information screen G5 and the recipe list screen G6 and so on described later. As the information for the shopping support screen G4, for example, the commodity information includes information indicating where the corresponding commodity is placed in the store. As the information for the commodity information screen G5, for example, the commodity information includes information relating to traceability. As the information for the recipe list screen G6, for example, the commodity information includes information of a recipe and so on of a cuisine in which the corresponding commodity is used.

FIG. 9 is a diagram showing storage content of the purchase commodity management table T5. As shown in FIG. 9, the purchase commodity management table T5 stores a customer ID. In addition, the purchase commodity management table T5 stores information of a visit date and time of the customer, and the purchase schedule information, corresponding to the customer ID. The information of a visit date and time includes a date and time when the customer corresponding to the customer ID visited the store. In addition, the purchase commodity management table T5 stores purchased information, corresponding to each candidate commodity included in the purchase schedule information. Specifically, the purchase commodity management table T5 stores purchased information, corresponding to the commodity ID of the candidate commodity, for example. The purchased information is flag information and so on showing whether or not the candidate commodity has been actually purchased.

The second purchase history management table T6 stores the above-described purchase history information. Specifically, the second purchase history management table T6 stores the purchase history information and so on except the comment information out of the storage content of the first purchase history management table T3 shown in FIG. 6. However, the above-described first purchase history management table T3 stores the purchase history information, in order to manage collectively the purchase history information of a plurality of stores (store servers 4) connected to the center server 3 via the network N1. On the other hand, the second purchase history management table T6 stores the purchase history information in order to manage the purchase history information of the own store.

The controller 41 of the store server 4 further includes a commodity extraction processor 411, a privilege imparting processor 412, an additional information provision processor 413, a customer ID acquisition processor 414, a purchase schedule acquirement processor 415, an in-store information provision processor 416, a purchase history management processor 417, a purchased setting processor 418 and an analysis processing processor 419, as shown in FIG. 7. Each of the processors 411-419 cooperates with a program stored in the ROM of the storage unit 45, to execute a processing for realizing a prescribed function. The processing which each of the processors 411-419 executes will be described later.

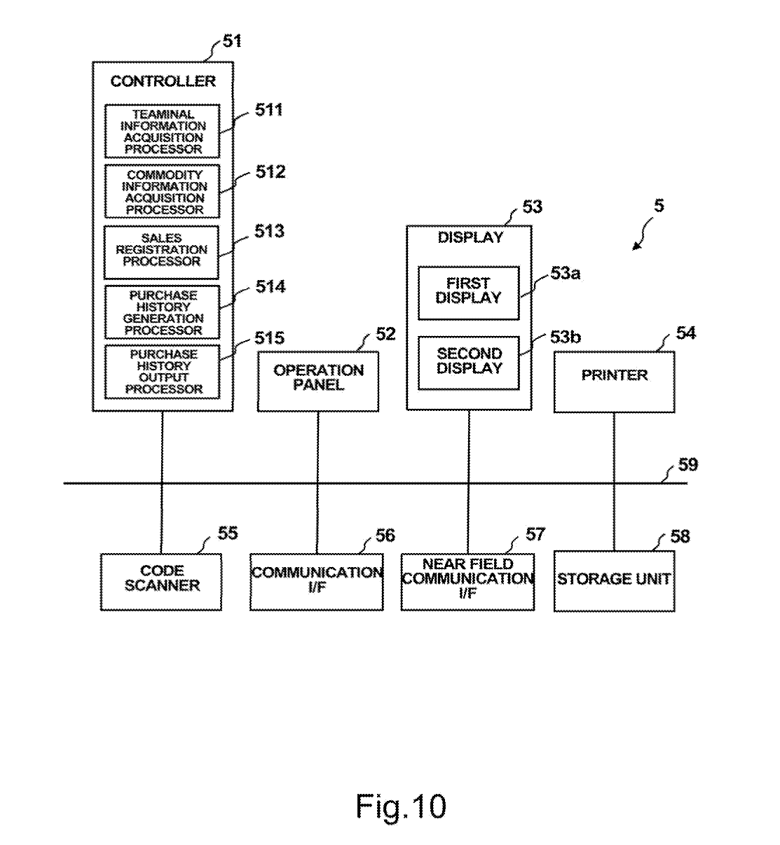

A configuration of the POS terminal 5 will be described with reference to FIG. 10. FIG. 10 is a block diagram showing the POS terminal 5. As shown in FIG. 10, the POS terminal 5 has a controller 51. The controller 51 executes various calculations, and integrated control of the respective units of the POS terminal 5. The controller 51 is a computer including a CPU, a RAM, a ROM, and an RTC unit and so on. The RAM is a main storage device of the controller 51. The ROM stores various programs and data. The RTC unit clocks current date and time.

The POS terminal 5 further has an operation panel 52, a display 53, a printer 54 and a code scanner 55. The operation panel 52, the display 53, the printer 54 and the code scanner 55 connect to the controller 51 via a bus 59.

The operation panel 52 has various operation keys. The operation keys include a register key, a cursor key, a selection determination key, a subtotal key, and a settlement key and so on, for example. The register key accepts an input of a numerical value by an employee of the store, for example. The cursor key and the selection determination key accept a selection input of a prescribed item by an employee of the store. The subtotal key accepts an operation input by an employee of the store, so as to instruct outputting a total amount of money of the commodities in which registrations of the sales are performed. The settlement key accepts an operation input by an employee of the store, so as to declare price settlement, by performing settlement processing of one transaction.

The display 53 is a liquid crystal display, for example. The display 53 displays various information, such as a commodity name and a commodity price of the commodity in which the above-described registration of the sales has been performed, a total sum of money of the one transaction in which the above-described settlement has been declared, an amount of a change. The display 53 has a first display 53a and a second display 53b. The first display 53a displays various information for an employee (casher) of the store. The second display 53b displays various information for a customer. The display 53 may be a display of a touch panel type. When the display 53 is a display of a touch panel type, the display 53 can double as the operation panel 52.

The printer 54 is a printer device which performs printing of a receipt and a journal and so on. The code scanner 55 is a scanner device which optically reads a code symbol such as a bar code and a two-dimensional code. The code symbol is a bar code or a two-dimensional code, and so on attached to a commodity, for example. The code scanner 55 reads a code symbol attached to a commodity, for example. The code scanner 55 further reads a code symbol displayed on the customer terminal 2, for example. The code scanner 55 reads a code symbol, to output information held in the code symbol to the controller 51. A code symbol attached to a commodity holds a commodity ID and so on which can discriminate the commodity, for example.

The POS terminal 5 further has a communication I/F 56 and a near field communication I/F 57. The communication I/F 56 and the near field communication I/F 57 connect to the controller 51 via the bus 59. The communication I/F 56 is connectable to the network N2. The communication I/F 56 is a transmission unit to transmit various information to the store server 4 and so on. Furthermore, the communication I/F 56 is a receiving unit to receive various information from the store server 4 and so on. In other words, the communication I/F 56 doubles as the transmission unit and the receiving unit. However, the communication I/F 56 is not limited to this configuration. For example, the POS terminal 5 may have the communication I/Fs 56 separately as the transmission unit and the receiving unit. The controller 51 performs exchange of various information with the store server 4 and so on, using the communication I/F 56. The near field communication I/F 57 is a near field communication interface which is based on a standard such as NFC. The near field communication I/F 57 is a transmission unit to transmit various information to the customer terminal 2 and so on. Furthermore, the near field communication I/F 57 is a receiving unit to receive various information from the customer terminal 2 and so on. In other words, the near filed communication I/F 57 doubles as the transmission unit and the receiving unit. However, the near filed communication I/F 57 is not limited to this configuration. For example, the POS terminal 5 may have the near filed communication I/Fs 57 separately as the transmission unit and the receiving unit. The controller 51 performs exchange of various information with a device which can perform near field communication, such as the customer terminal 2 and so on, using the near field communication I/F 57.

The POS terminal 5 further has a storage unit 58. The storage unit 58 is an auxiliary storage device, such as an HDD or an SSD. The storage unit 28 stores a program for executing various POS affairs including commodity sales data processing described later, and various data. Furthermore, the storage unit 28 previously stores the store ID and so on of the own store.

The controller 51 of the POS terminal 5 further includes a terminal information acquisition processor 511, a commodity information acquisition processor 512, a sales registration processor 513, a purchase history generation processor 514, and a purchase history output processor 515, as shown in FIG. 10. Each of the processors 511-515 cooperates with a program stored in the ROM or the storage unit 58, to execute a processing for realizing a prescribed function. The processing which each of the processors 511-515 executes will be described later.

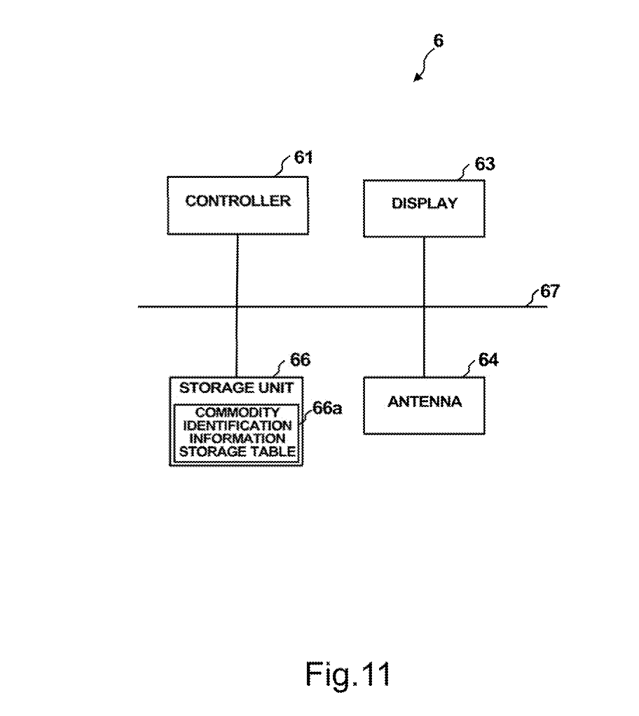

A configuration of the electronic shelf tag 6 will be described with reference to FIG. 11. FIG. 11 is a block diagram showing the electronic shelf tag 6. As shown in FIG. 11, the electronic shelf tag 6 has a controller 61, and an antenna 64. The controller 61 controls information communication. The antenna 64 transmits/receives a radio wave of the information communication. The antenna 64 connects to the controller 61 via a bus 67. The controller 61 and the antenna 64 cooperate with each other, to communicate with the customer terminal 2.

In addition, as shown in FIG. 11, the electronic shelf tag 6 has a display 63. The display 63 connects to the controller 61 via the bus 67. The controller 61 controls the display operation of the display 63. Based on the control of the controller 61, the display 63 displays the commodity information stored in a commodity identification information storage table 66a of a storage unit 66 described later. The commodity information which the display 63 displays is a commodity name and a price of the commodity (a unit price, for example) and so on, for example.

In addition, as shown in FIG. 11, the electronic shelf tag 6 has the storage unit 66. The storage unit 66 connects to the controller 61 via the bus 67. The controller 61 controls the storage unit 66. The storage unit 66 has the commodity identification information storage table 66a. FIG. 12 is a diagram showing the storage content of the commodity identification information storage table 66a. As shown in FIG. 12, the commodity identification information storage table 66a stores the above-described commodity ID. In addition, the commodity identification information storage table 66a stores the above-described commodity information, corresponding to the commodity ID. The commodity ID stored in the commodity identification information storage table 66a is identification information of a commodity, so as to identify the commodity which the display 63 displays in the commodity information screen G5 and the recipe list screen G6 and so on described later. As described above, the commodity information includes the commodity name, the price of the commodity as described above, and various information which the display 63 displays in the commodity information screen G5 and the recipe list screen G6 and so on described later.

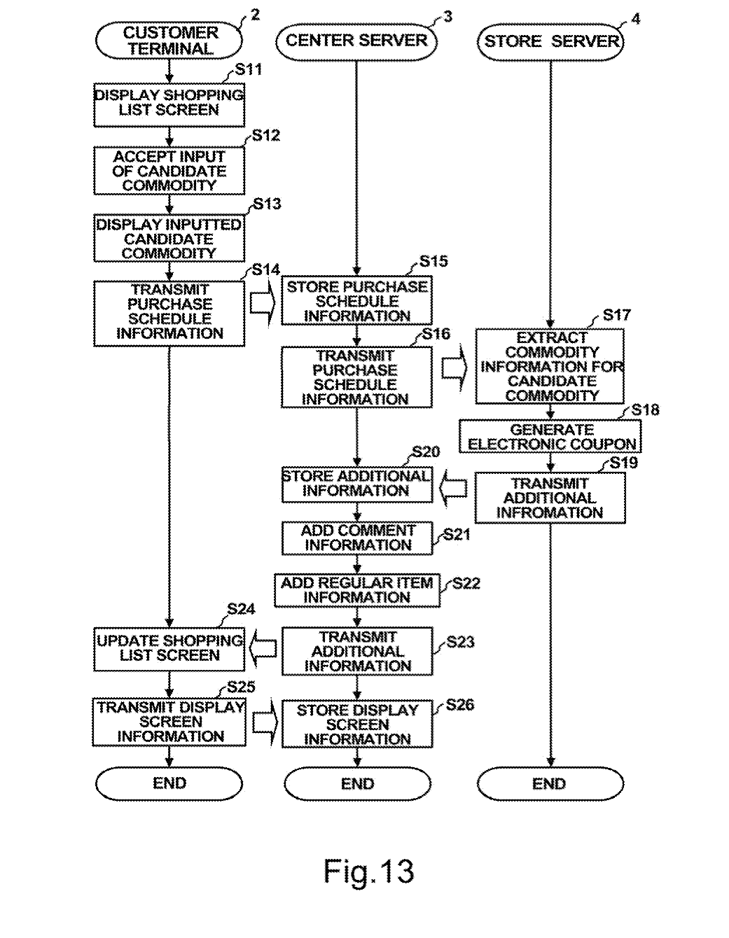

Hereinafter, processings which the respective devices of the shopping support system 1 execute will be described, including processings which the controllers of the respective devices, and the processors of the respective controllers execute. To begin with, a first creation support processing relating to creation of a shopping list will be described with reference to FIG. 13 to FIG. 15. This first creation support processing is a processing so as to add a commodity which is inputted by the customer terminal 2 to a shopping list, as a candidate commodity.

FIG. 13 is a flow chart showing a first creation support processing by the shopping support system 1. In the first creation support processing, the shopping list creation support processor 211 of the customer terminal 2 provides various GUIs (Graphical User Interface), such as a shopping list screen and so on described later, to a customer who is an operator of the customer terminal 2.

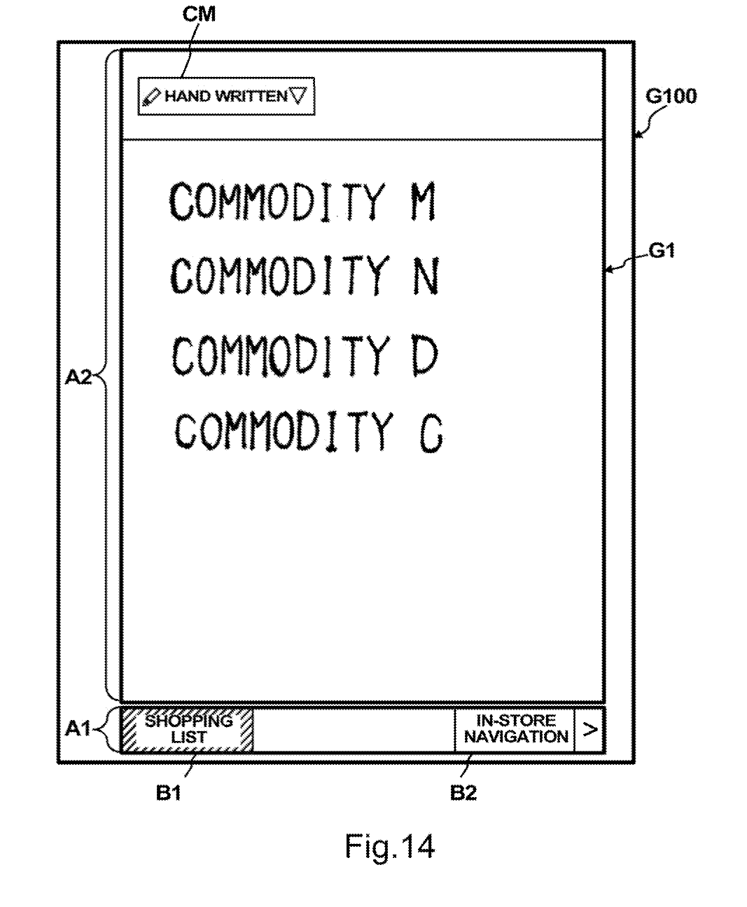

Specifically, as shown in FIG. 13, in a processing step S11 of the customer terminal 2, the shopping list creation support processor 211 of the customer terminal 2 displays a shopping guide screen G100 (refer to FIG. 14) including a shopping list screen G1, using the display 23. For example, the shopping list creation support processor 211 controls the display operation of the display 23, so as to display the shopping guide screen G100, using the display 23. The display 23 is controlled by the shopping list creation support processor 211, to display the shopping guide screen G100. At the time of a log-in to the customer terminal 2 by a customer, or when the display 23 displays the shopping guide screen G100, and so on, the operation panel 22 accepts a customer ID inputted by the customer, for example. Accompanied with the input of the customer ID by the customer, the customer terminal 2 notifies the center server 3 of information (an IP address and so on, for example) with which the customer accesses to the own device, along with the above-described accepted customer ID, using the communication I/F 26. For example, the shopping list creation support processor 211 of the customer terminal 2 controls the communication operation of the communication I/F 26, so as to notify the center server 3 of the above-described access information and customer ID to the center server 3, using the communication I/F 26. The communication I/F 26 is controlled by the shopping list creation support processor 211, to transmit the above-described access information and customer ID to the center server 3.

FIG. 14 is a diagram showing the above-described shopping guide screen G100 in the above-described step S11. As shown in FIG. 14, the shopping guide screen G100 has a first area A1 and a second area A2. In the first area A1, an operator for switching a display mode of the screen displayed in the second area A2 is displayed. In other words, the display 23 is controlled by the shopping list creation support processor 211, to display the operator for switching the above-described display mode, in the first area A1. In the second area A2, various screens such as the shopping list screen G1 are displayed. In other words, the display 23 is controlled by the shopping list creation support processor 211, to display various screens such as the shopping list screen G1 in the second area A2.

In the above-described step S11, the operators for switching the above-described display mode include a shopping list button B1, and an in-house navigation button B2, as shown in FIG. 14. The button B1 is an operator to accept a touch operation by a customer, so as to switch the screen to be displayed in the above-described second area A2 to the shopping list screen G1. In the button B1, a character string of “SHOPPING LIST”, for example, is displayed, so as to guide the function of the button to a customer. The button B2 is an operator to accept a touch operation by a customer, so as to switch the screen to be displayed in the above-described second area A2, to the shopping support screen G4 described later. In the button B2, a character string of “IN-STORE NAVIGATION”, for example, is displayed, so as to guide the function of the button to a customer.

When the button B1 accepts a touch operation (selection) by a customer, the shopping list creation support processor 211 controls the display operation of the display 23, so as to display the shopping list screen G1 in the above-described second area A2, using the display 23. The display 23 is controlled by the shopping list creation support processor 211, to display the shopping list screen G1 in the second area A2 of the shopping guide screen G100, as shown in FIG. 14. The shopping list screen G1 displays a shopping list and a switching menu button CM. The shopping list is a list of the candidate commodity inputted by the customer. The switching menu button CM is an operator which accepts a touch operation by a customer, so as to switch an input mode by the customer for the shopping list screen G1. When the switching menu button CM accepts the touch operation by the customer for selecting a desired input mode, the shopping list creation support processor 211 accepts an input of a candidate commodity, so as to create the shopping list, with a method according to the input mode selected by the customer, in the shopping list screen G1 in the second area A2.

Specifically, the input mode has a handwritten character input mode, a sound input mode, a key input mode, a code input mode, and an image input mode, for example. The handwritten character input mode is an input mode by a handwritten character. The sound input mode is an input mode by sound. The key input mode is an input mode by key typing. The code input mode is an input mode by reading a code symbol (a bar code and so on). The image input mode is an input mode by image recognition. When the switching menu button CM accepts the touch operation by the customer for displaying the menu of the input mode, the shopping list creation support processor 211 controls the display operation of the display 23, so as to display the menu of the input mode, using the display 23. The display 23 displays a plurality of the above-described input modes as the menu of the input mode. In the state where the menu of the input mode is displayed, the customer can select any one input mode out of a plurality of the above-described input modes. The switching menu button CM accepts the touch operation by the customer for selecting an input mode, to accept the selection of the input mode by the customer. When the switching menu button CM accepts the selection of an input mode by the customer, the shopping list creation support processor 211 judges the input mode selected by the customer. When the shopping list creation support processor 211 judges the input mode selected by the customer, the processing of the shopping support system 1 proceeds to a processing step S12 of the customer terminal 2.

In the step S12, the shopping list creation support processor 211 of the customer terminal 2 accepts input of a candidate commodity by the customer, with a method according to the input mode selected by the customer. When the shopping list creation support processor 211 accepts the input of the candidate commodity by the customer, using the display and so on, the processing of the shopping support system 1 proceeds to a processing step S13 of the customer terminal 2. In the step S13, the shopping list creation support processor 211 displays the candidate commodity inputted by the customer in the shopping list screen G1, using the display 23. For example, the shopping list creation support processor 211 controls the display operation of the display 23, so as to display the candidate commodity inputted by the customer in the shopping list screen G1, using the display 23. The display 23 is controlled by the shopping list creation support processor 211, to display the candidate commodity in the shopping list screen G1, as the shopping list. The above-described inputted candidate commodity may be of a concrete name, or may be of a common name.

For example, when the switching menu button CM accepts the selection of the handwritten character input mode, as the above-described input mode, the shopping list creation support processor 211 judges that the input mode selected by the customer is the handwritten character input mode. The shopping list creation support processor 211 controls the display operation of the display 23, so as to accept the handwritten characters of the customer for the shopping list screen G1 using the display 23. The display 23 is controlled by the shopping list creation support processor 211, to accept the handwritten characters of the customer, and output input data corresponding to the handwritten characters, in the shopping list screen G1. The shopping list creation support processor 211 recognizes a character string expressing a commodity name (a common name, for example) of the candidate commodity, from the input data of the handwritten characters outputted by the display 23, using a publicly-known handwritten character recognition technology. FIG. 14 is a diagram showing the shopping list screen G1 included in the shopping guide screen G100, in which handwritten characters corresponding to character strings “COMMODITY M”, “COMMODITY N”, “COMMODITY D”, and “COMMODITY C” are inputted, as commodity names of the common names of the candidate commodities, by the customer, for example. As shown in FIG. 14, when the handwritten characters are inputted in the shopping list screen G1 by the customer, the shopping list creation support processor 211 recognizes the character strings “COMMODITY M”, “COMMODITY C” and so on, as the common names of the commodity names of the candidate commodities, from the input data corresponding to the handwritten characters outputted by the display 23. The shopping list creation support processor 211 recognizes the commodity name of the candidate commodity, to judge the candidate commodity inputted by the customer. The display 23 may hold the display of the handwritten characters in the shopping list screen G1, after the recognition of the above-described handwritten characters. Furthermore, the display 23 may re-display the handwritten characters shown in FIG. 14, into the character string after the recognition of the above-described handwritten characters with a prescribed typeface.

For example, when the switching menu button CM accepts the selection of the sound input mode, as the above-described input mode, the shopping list creation support processor 211 judges that the input mode selected by the customer is the sound input mode. The shopping list creation support processor 211 controls the sound input operation of the sound input unit 25, so as to accept the sound of the customer, using the sound input unit 25. The sound input unit 25 is controlled by the shopping list creation support processor 211, to accept the sound of the customer, and output input data corresponding to the sound. The shopping list creation support processor 211 recognizes a character string expressing a commodity name (common name, for example) of the candidate commodity, from the above-described input data outputted by the sound input unit 25, using a publicly-known sound recognition technology. The shopping list creation support processor 211 recognizes the character string expressing the commodity name, to judge the candidate commodity inputted by the customer. For example, when the switching menu button CM accepts the selection of the key input mode, as the above-described input mode, the shopping list creation support processor 211 judges that the input mode selected by the customer is the key input mode. The shopping list creation support processor 211 controls the key input operation of the operation panel 22, so as to accept the key input of the customer, using the operation panel 22. The operation panel 22 is controlled by the shopping list creation support processor 211, to accept the key input and output input data corresponding to the key input. The shopping list creation support processor 211 recognizes a character string expressing a commodity name (common name, for example) of the candidate commodity, from the above-described input data outputted by the operation panel 22. The shopping list creation support processor 211 recognizes the character string expressing the commodity name, to judge the candidate commodity inputted by the customer.

For example, when the switching menu button CM accepts the selection of the code input mode, as the above-described input mode, the shopping list creation support processor 211 judges that the input mode selected by the customer is the code input mode. The shopping list creation support processor 211 controls the imaging operation of the imaging unit 24, so as to accept the code input of a customer, using the imaging unit 24. The imaging unit 24 is controlled by the shopping list creation support processor 211, to image the code symbol, and output input data corresponding to the code symbol. The shopping list creation support processor 211 decodes the input data corresponding to the above-described code symbol outputted by the imaging unit 24, using a publicly-known reading technology. The shopping list creation support processor 211 recognizes the character string (commodity ID) acquired by decoding, as a character string expressing a commodity name of the candidate commodity. The shopping list creation support processor 211 recognizes the character string expressing the commodity name, to judge the candidate commodity inputted by the customer. When the commodity name can be identified from the above-described commodity ID, the shopping list creation support processor 211 judges the commodity name corresponding to the commodity ID, as the candidate commodity.

For example, when the switching menu button CM accepts the selection of the image input mode, as the above-described input mode, the shopping list creation support processor 211 judges that the input mode selected by the customer is the image input mode. The shopping list creation support processor 211 controls the imaging operation of the imaging unit 24, so as to input an image of a candidate commodity, using the imaging unit 24. The imaging unit 24 is controlled by the shopping list creation support processor 211, to image the image of the candidate commodity, and output input data corresponding to the image of the candidate commodity. The shopping list creation support processor 211 recognizes a commodity name of the commodity name, from the above-described input data outputted from the above-described imaging unit 24, using a publicly-known object recognition technology. The shopping list creation support processor 211 recognizes the commodity name of the candidate commodity, to judge the candidate commodity inputted by the customer.

As described above, when the input mode selected by the customer is the handwritten character input mode, an input accepting unit to accept the input of the candidate commodity by the customer is the display 23. When the input mode selected by the customer is the sound input mode, an input accepting unit to accept the input of the candidate commodity by the customer is the sound input unit 25. When the input mode selected by the customer is the key input mode, an input accepting unit to accept the input of the candidate commodity by the customer is the operation panel 22. When the input mode selected by the customer is the code input mode or the image input mode, an input accepting unit to accept the input of the candidate commodity by the customer is the imaging unit 24. Accordingly, in the above-described step S12, the input accepting unit corresponding to the above-described input mode accepts the above-described candidate commodity. The shopping list creation support processor 211 judges the candidate commodity which has been accepted by the input accepting unit. In the above-described step S13, the display 23 displays the commodity name (common name) of the candidate commodity which has been judged by the shopping list creation support processor 211, in the shopping list screen G1. When the shopping list creation support processor 211 displays the candidate commodity in the shopping list screen G1, using the display 23, the processing of the shopping support system 1 proceeds to a processing step S14 of the customer terminal 2. In the step S14, the shopping list creation support processor 211 generates purchase schedule information including the commodity name, and the commodity ID of the above accepted candidate commodity. The shopping list creation support processor 211 transmits the above-described purchase schedule information, along with the customer ID, to the center server 3, using the communication I/F 26. For example, the shopping list creation support processor 211 controls the communication operation of the communication I/F 26, so as to transmit the above-described purchase schedule information, along with the customer ID, to the center server 3, using the communication I/F 26. The communication I/F 26 is controlled by the shopping list creation support processor 211, to transmit the purchase schedule information, along with the customer ID, to the center server 3. The shopping list creation support processor 211 may transmit the purchase schedule information to the center server 3, using the communication I/F 26, each time the above-described candidate commodity is accepted by the above-described input accepting unit, or may transmit a plurality of candidate commodities to the center server 3 all at once, in accordance with the acceptance of a prescribed operation and so on by a customer.

When the shopping list creation support processor 211 transmits the purchase schedule information, along with the customer ID, to the center server 3, using the communication I/F 26, the processing of the shopping support system 1 proceeds to a processing step S15 of the center server 3. In the step S15, the mediation processing processor 311 of the center server 3 receives the customer ID and the purchase schedule information from the customer terminal 2, using the communication I/F 34. For example, the mediation processing processor 311 controls the communication operation of the communication I/F 34, so as to receive the customer ID and the purchase schedule information from the customer terminal 2, using the communication I/F 34. The communication I/F 34 is controlled by the mediation processing processor 311, to receive the customer ID and the purchase schedule information from the customer terminal 2. In addition, the mediation processing processor 311 stores the customer ID and the purchase schedule information, using the storage unit 35. For example, the mediation processing processor 311 controls the storage operation of the storage unit 35, so as to store the customer ID and the purchase schedule information, using the storage unit 35. The shopping list management table T2 of the storage unit 35 is controlled by the mediation processing processor 311, to store the above received customer ID and purchase schedule information. When the mediation processing processor 311 stores the customer ID and the purchase schedule information, using the shopping list management table T2, the processing of the shopping support system 1 proceeds to a processing step 16 of the center server 3. In the step S16, the mediation processing processor 311 of the center server 3 transmits the above received customer ID and purchase schedule information, to the store server 4, using the communication I/F 34. For example, the mediation processing processor 311 controls the communication operation of the communication I/F 34, so as to transmit the above received customer ID and purchase schedule information, to the store server 4, using the communication I/F 34. The communication I/F 34 is controlled by the mediation processing processor 311, to transmit the customer ID and the purchase schedule information to the store server 4.

In the above-described step S16, the store server 4 that becomes a transmission destination of the customer ID and the purchase schedule information is not limited. For example, the mediation processing processor 311 selects the whole store servers 4 connected to the center server 3, as the above-described transmission destinations. The communication I/F 34 transmits the customer ID and the purchase schedule information to the store servers 4 of the selected stores. In addition, the mediation processing processor 311 selects the store server 4 that becomes the above-described transmission destination, based on the purchase history information stored in the first purchase history management table T3, for example. Specifically, the mediation processing processor 311 extracts the purchase history information which has been stored corresponding to the customer ID transmitted from the customer terminal 2, from the first purchase history management table T3. The mediation processing processor 311 selects the store server 4 corresponding to the store ID included in the extracted purchase history information, as the above-described transmission destination. For example, the mediation processing processor 311 selects the store servers corresponding to the whole store IDs included in the above extracted purchase history information, as the above-described transmission destinations. In addition, the mediation processing processor 311 selects the store server 4 corresponding to the store ID satisfying a specific condition, out of the store IDs (stores) included in the above extracted purchase history information, as the above-described transmission destination, for example. The store ID (store) satisfying a specific condition is a store ID of a store in which the number of the above extracted purchase history information is not less than a prescribed value, for example. Furthermore, the store ID satisfying a specific condition is a store ID of a store in which the candidate commodity included in the above-described purchase schedule information has been purchased by the customer corresponding to the above-described customer ID, for example. The communication I/F 34 transmits the customer ID and the purchase schedule information to the store server 4 of the above-described selected store.

When the mediation processing processor 311 transmits the above-described customer ID and purchase schedule information to the store server 4, using the communication I/F 34, the processing of the shopping support system 1 proceeds to a processing step S17 of the store server 4. In the step S17, the commodity extraction processor 411 of the store server 4 receives the customer ID and the purchase schedule information from the center server 3, using the communication I/F 44. For example, the commodity extraction processor 411 controls the communication operation of the communication I/F 44, so as to receive the customer ID and the purchase schedule information from the center server 3, using the communication I/F 44. The communication I/F 44 is controlled by the commodity extraction processor 411, to receive the customer ID and the purchase schedule information from the center server 3. The commodity extraction processor 411 extracts the commodity information which has been stored corresponding to the candidate commodity included in the purchase schedule information received by the communication I/F 44, from the commodity management table T4.

In the above-described step S17, when the commodity name of the above-described candidate commodity is expressed by a concrete name, the commodity extraction processor 411 extracts the commodity information which has been stored corresponding to the relevant concrete name, from the commodity management table T4. For example, when the commodity name of the above-described candidate commodity is expressed by a common name, the commodity extraction processor 411 extracts the commodity information which has been stored corresponding to the relevant common name, from the commodity management table T4. For example, when the above-described candidate commodity is expressed by a commodity ID, the commodity extraction processor 411 extracts the commodity information which has been stored corresponding to the relevant commodity ID, from the commodity management table T4.

When the commodity extraction processor 411 extracts the commodity information which has been stored corresponding to the candidate commodity included in the purchase schedule information, from the commodity management table T4, the processing of the shopping support system 1 proceeds to a processing step S18 of the store server 4. In the step S18, the privilege imparting processor 412 of the store server 4 generates (issues) an electronic coupon instructing to impart privilege such as a discount and point imparting to the candidate commodity, to the candidate commodity included in the purchase schedule information which the commodity extraction processor 411 has received.

In the above-described step S18, the candidate commodity that becomes a privilege imparting object is not limited. For example, when it is previously determined that a privilege is imparted to a specific commodity, the privilege imparting processor 412 generates an electronic coupon to the candidate commodity corresponding to the above-described specific commodity, out of the candidate commodities included in the purchase schedule information which the commodity extraction processor 411 has received.

In addition, the privilege imparting processor 412 dynamically determines a commodity that becomes a privilege imparting object and a privilege content, for example. Specifically, the privilege imparting processor 412 refers to the commodity information or the purchase history information stored corresponding to the above-described customer ID which has been received from the center server 3, from the purchase commodity management table T5 or the second purchase history management table T6. The privilege imparting processor 412 determines a commodity that becomes a privilege imparting object and a privilege content, based on a purchase rate described later obtained from the referred commodity information or purchase history information, and the purchase result. The privilege imparting object is not limited to a commodity unit, but may be the whole commodities, or may be a store visitor to the own store. In addition, the privilege imparting processor 412 may determine an expiration time, and so on to the above-described electronic coupon.

When the privilege imparting processor 412 generates an electric coupon to each of the candidate commodities included in the purchase schedule information which has been accepted by the commodity extraction processor 411, the processing of the shopping support system 1 proceeds to a step S19 of the store server 4. In the step S19, the additional information provision processor 4 of the store server 4 generates additional information which is added to each of the candidate commodities included in the purchase schedule information which has been accepted by the commodity extraction processor 411. The above-described additional information includes the commodity information of each of the candidate commodities extracted by the commodity extraction processor 411. In addition, the above-described additional information includes the electronic coupon generated (issued) by the privilege imparting processor 412. Furthermore, the above-described additional information includes the store ID of the own store. The additional information provision processor 413 transmits the above-described additional information to the center server 3, using the communication I/F 44. For example, the additional information provision processor 413 controls the communication operation of the communication I/F 44, so as to transmit the above-described additional information to the center server 3, using the communication I/F 44. The communication I/F 44 is controlled by the additional information provision processor 413, to transmit the above-described additional information, along with the customer ID received from the center server 3, to the center server 3.

In the above-described step S19, the information to be included in the above-described additional information is not limited to the above, but may include other information. For example, the additional information may include advertisement information for advertising the own store and a specific commodity and so on. The advertisement information may be previously prepared, or may be dynamically generated by the additional information provision processor 413 and so on, based on the commodity information and so on extracted by the commodity extraction processor 411.

When the additional information provision processor 413 transmits the above-described additional information, along with the customer ID, to the center server 3, using the communication I/F 44 of the store server 4, the processing of the shopping support system 1 proceeds to a processing step S20 of the center server 3. In the step S20, the mediation processing processor 311 of the center server 3 receives the customer ID and the additional information from the store server 4, using the communication I/F 34. For example, the mediation processing processor 311 controls the communication operation of the communication I/F 34, so as to receive the customer ID and the additional information from the store server 4, using the communication I/F 34. The communication I/F 34 is controlled by the mediation processing processor 311, to receive the customer ID and the above-described additional information from the store server 4. In addition, the mediation processing processor 311 controls the storage operation of the storage unit 35, so as to store the above-described received additional information, using the storage unit 35. The shopping list management table T2 of the storage unit 35 is controlled by the mediation processing processor 311, to store the above-described additional information corresponding to the customer ID received by the communication I/F 34.

When the mediation processor 311 stores the above-described additional information, using the storage unit 35, the processing of the shopping support system 1 proceeds to a processing step S21 of the center server 3. In the step S21, the comment adding processor 312 of the center server 3 adds the comment information stored in the first purchase history management table T3 of the storage unit 35, to the commodity information of the candidate commodity included in the additional information accepted by the above-described mediation processor 311. Specifically, the comment adding processor 312 refers to the purchase history information stored in the first purchase history management table T3, corresponding to the customer ID accepted by the mediation processor 311. Furthermore, the comment adding processor 312 refers to the comment information stored in the first purchase history management table T3, corresponding to the commodity ID included in this referred purchase history information. The comment adding processor 312 reads the comment information corresponding to the candidate information from the first purchase history management table T3, out of the referred comment information. In addition, the comment adding processor 312 adds the read comment information to the commodity information of the candidate information included in the above-described additional information.

When the comment adding processor 312 adds the above-described comment information to the commodity information of the candidate commodity included in the additional information, the processing of the shopping support system 1 proceeds to a processing step S22 of the center server 3. In the step S22, the regular item adding processor 313 of the center server 3 adds regular item information expressing a regular item, to the commodity information of the candidate commodity included in the above-described additional information. The regular item adding processor 313 refers to the purchase history information stored in the first purchase history management table T3, corresponding to the customer ID accepted from the store server 4 by the above-described mediation processor 311. Furthermore, the regular item adding processor 313 specifies a commodity in which the number of purchase histories is not less than a prescribed value, for each purchase commodity group in the same category (common name, for example) as the above-described candidate commodity, as a regular item, out of the purchase commodities included in this referred purchase history information. The regular item adding processor 313 may specify a commodity having the largest number of purchase histories as a regular item. The regular item adding processor 312 adds the regular item information indicating the above-described specified regular item, to the commodity information of the relevant candidate commodity included in the above-described additional information.

When the regular item adding processor 313 adds the above-described regular item information to the commodity information of the candidate commodity included in the above-described additional information, the processing of the shopping support system 1 proceeds to a processing step S23 of the center server 3. In the step S23, the mediation processing processor 311 of the center server 3 transmits the additional information in which the comment information and the regular item information are added to the commodity information of the candidate commodity, to the customer terminal 2, using the communication I/F 34. For example, the mediation processing processor 311 controls the communication operation of the communication I/F 34, so as to transmit the above-described adding information to the customer terminal 2, using the communication I/F 34. The communication I/F 34 is controlled by the mediation processing processor 311, to transmit the additional information in which the comment information and the regular item information are added to the commodity information of the candidate commodity, to the customer terminal 2 of the customer ID (refer to the step S20) received from the store server 4.

When the mediation processor 311 transmits the above-described additional information using the communication I/F 34, the processing of the shopping support system 1 proceeds to a processing step S24 of the customer terminal 2. In the step S24, the shopping list creation support processor 211 of the customer terminal 2 receives the above-described additional information in which the above-described comment information and the above-decried regular item information are added to the commodity information of the candidate commodity, from the center server 3, using the communication I/F 26. For example, the shopping list creation support processor 211 controls the communication operation of the communication I/F 26, so as to receive the above-described additional information from the center server 3, using the communication I/F 26. The communication I/F 26 is controlled by the shopping list creation support processor 211, to receive the above-described additional information from the center server 3. In addition, the shopping list creation support processor 211 updates the display content of the shopping list screen G1, using the display 23. For example, the shopping list creation support processor 211 controls the display operation of the display 23, so as to update the display content of the shopping list screen G1, using the display 23. The display 23 is controlled by the shopping list creation support processor 211, to update the display content of the candidate commodity in the shopping list screen G1, based on the information of the electronic coupon and the regular item information included in the above-described additional information which has been received from the center server 3.

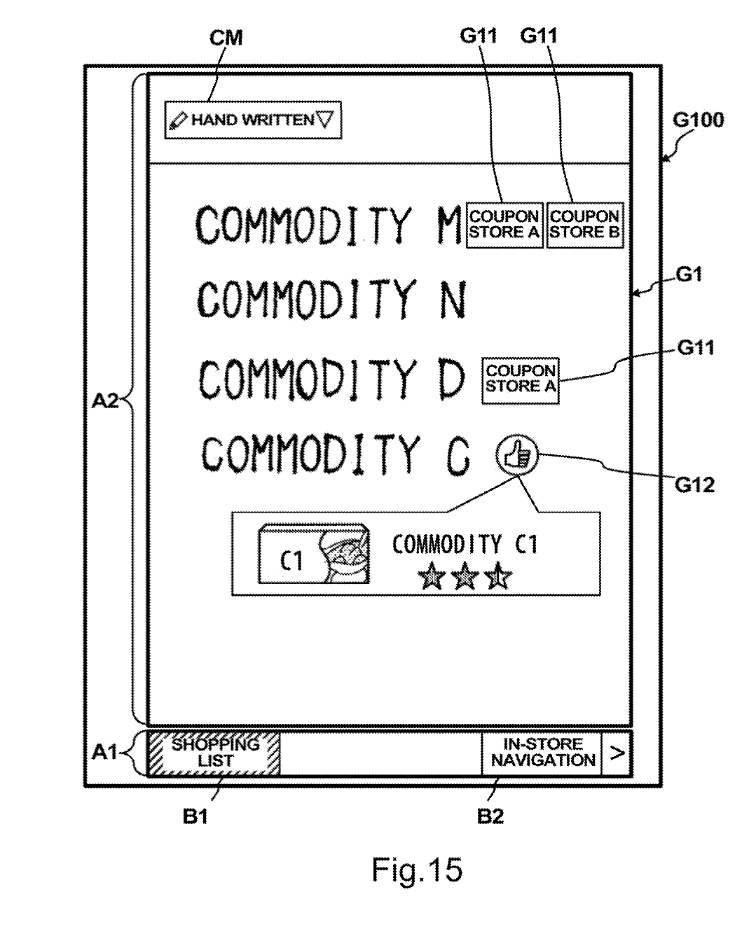

FIG. 15 is a diagram showing an example of the shopping list screen G1 after update. As shown in FIG. 15, the display unit 23 adds a coupon icon to the shopping list screen G1, to display the shopping list screen G1 after update. A coupon icon G11 is an identifier indicating that an electronic coupon has been provided to the relevant candidate commodity. The display unit 23 displays the coupon icon G11, corresponding to the relevant candidate commodity. In the coupon icon G11, a character string (“coupon”, for example) indicating that an electronic coupon is provided to the relevant candidate commodity, and a character string (“store A”, for example) showing a name of a store providing the electronic coupon are displayed. For example, in FIG. 15, the candidate commodity “COMMODITY M” shows that electronic coupons are provided from a store A and a store B. In addition, the candidate commodity “COMMODITY D” shows that an electronic coupon is provided from the store A. In other words, the shopping list screen G1 after update shows that regarding the candidate commodities “COMMODITY M” and “COMMODITY D”, commodities to which an electronic coupon has been provided are present in the store A. In addition, the shopping list screen G1 after update shows that regarding the candidate commodity “COMMODITY D”, a commodity to which an electronic coupon has been provided is present in the store B.

In addition, the display unit 23 displays a comment icon G12, corresponding to the commodity name of the candidate commodity, in the shopping list screen G1 (refer to FIG. 15). The comment icon G12 is an identifier indicating that a commodity added with the above-described comment information is present. FIG. 15 shows that a commodity added with the comment information is present, regarding the candidate commodity “COMMODITY C”. For example, when the shopping list screen G1 accepts selection of the comment icon G12 by a touch operation of a customer, the shopping list creation support processor 211 controls the display operation of the display 23, so as to display the commodity information and the comment information, using the display 23, regarding the candidate commodity to which the comment icon G12 is made to correspond. FIG. 15 shows the shopping list screen G1, when the shopping list screen G1 has accepted the selection of the comment icon G12 which is made to correspond to the candidate commodity “COMMODITY C”. The display 23 is controlled by the shopping list creation support processor 211, to display a character string of “COMMODITY C1” indicating a concrete name and an image of the commodity C1, as the commodity information, regarding the candidate commodity “COMMODITY C”, as shown in FIG. 15. Furthermore, the display unit 23 displays stars indicating the evaluation for a commodity C1 by a plurality of customers, as the comment information, as shown in FIG. 15.

As described above, a customer who is an operator of the customer terminal 2 can select and display a concrete name of a desired commodity, out of the concrete name of the commodity included in the additional information, for the candidate commodity inputted in the customer terminal 2. By this means, the customer can select the candidate commodity, while confirming the information of the commodity and the electronic coupon provided from each store. Accordingly, the shopping support system 1 can achieve sales promotion of the commodity, and can improve convenience relating to commodity selection. In the above-described embodiment, it is not essential that the shopping list screen G1 of the customer terminal 2 displays the concrete names of the whole candidate commodities. A candidate commodity expressed by a common name may be present, out of a plurality of candidate commodities which the shopping list screen G1 displays.

In FIG. 13, when the display unit 23 displays the updated shopping list screen G1 (refer to FIG. 15), the processing of the shopping support system 1 proceed to a processing step S25 of the customer terminal 2. In the step S25, the shopping list creation support processor 211 of the customer terminal 2 transmits the display screen information of the shopping list screen G1, along with the customer ID, to the center server 3, using the communication I/F 26. For example, the shopping list creation support processor 211 controls the communication operation of the communication I/F 26, so as to transmit the display screen information of the shopping list screen G1, along with the customer ID, to the center server 3, using the communication I/F 26. The display screen information includes data set for realizing or reproducing the display state of the shopping list displayed (inputted) in the shopping list screen G1. The communication I/F 26 is controlled by the shopping list creation support processor 211, to transmit the display screen information along with the customer ID, to the center server 3.

When the communication I/F 26 of the customer terminal 2 transmits the display screen information to the center server 3, the processing of the shopping support system 1 proceeds to a processing step S26 of the center server 3. In the step S26, the mediation processing processor 311 of the center server 3 receives the customer ID and the display screen information from the customer terminal 2, using the communication I/F 34. For example, the mediation processing processor 311 controls the communication operation of the communication I/F 34, so as to receive the customer ID and the display screen information from the customer terminal 2, using the communication I/F 34. The communication I/F 34 is controlled by the mediation processing processor 311, to receive the customer ID and the display screen information. The mediation processing processor 311 controls the storage operation of the storage unit 35, so as to store the above-described received display screen information, using the storage unit 35. The shopping list management table T2 of the storage unit 35 is controlled by the mediation processing processor 311, to store the above-described display screen information corresponding to the above-described received customer ID.

After the shopping list management table T2 stores the display screen information, the shopping list creation support processor 211 and the mediation processing processor 311 cooperate with each other, and thereby the customer terminal 2 and the center server 3 execute synchronous processing of the purchase schedule information, the additional information and the display screen information which are stored in them, respectively. Specifically, when in one device of the customer terminal 2 and the center sever 3, any of the purchase schedule information, the additional information and the display screen information is updated, the other device updates any of the purchase schedule information, the additional information and the display screen information so that the updated content is reflected.

Furthermore, when the communication I/F 34 of the center server 3 receives the notification of the customer ID from the relevant customer terminal 2 at the time of starting the customer terminal 2, the mediation processing processor 311 reads the purchase schedule information, the additional information and the display screen information corresponding to this customer ID, from the shopping list management table T2. The mediation processing processor 311 provides the above read purchase schedule information, additional information and display screen information to the customer terminal 2, using the communication I/F 34. For example, the mediation processing processor 311 controls the communication operation of the communication I/F 34, so as to provide the above read purchase schedule information, additional information and display screen information, using the communication I/F 34. The communication I/F 34 is controlled by the mediation processing processor 311, to transmit the purchase schedule information, the additional information and the display screen information to the customer terminal 2. The shopping list creation support processor 211 of the customer terminal 2 receives the above-described purchase schedule information, additional information and display screen information from the center server 3, using the communication I/F 26. For example, the shopping list creation support processor 211 controls the communication operation of the communication I/F 26, so as to receive the above-described purchase schedule information, additional information and display screen information from the center server 3, using the communication I/F 26. The communication I/F 26 is controlled by the shopping list creation support processor 211, to receive the above-described purchase schedule information, additional information and display screen information from the center server 3. The shopping list creation support processor 211 of the customer terminal 2 compares the above-described respective information (the purchase schedule information, the additional information and the display screen information) received by the communication I/F 26, with the respective information (the purchase schedule information, the additional information and the display screen information) which are locally stored by the storage unit 28. The storage unit 28 updates the storage content to the information whose update date and time is newer, based on the above-described comparison result by the shopping list creation support processor 211.

The customer terminal 2 updates the respective information, as described above, and thereby a customer inputs the same customer ID to an optional customer terminal 2, and can make the optional customer terminal 2 display the shopping list which the relevant customer has created. For example, the customer creates a shopping list on the large customer terminal 2 such as a tablet, and can make a portable and small customer terminal 2 display the shopping list. Accordingly, the shopping support system 1 can improve convenience relating to the usage of the shopping list.

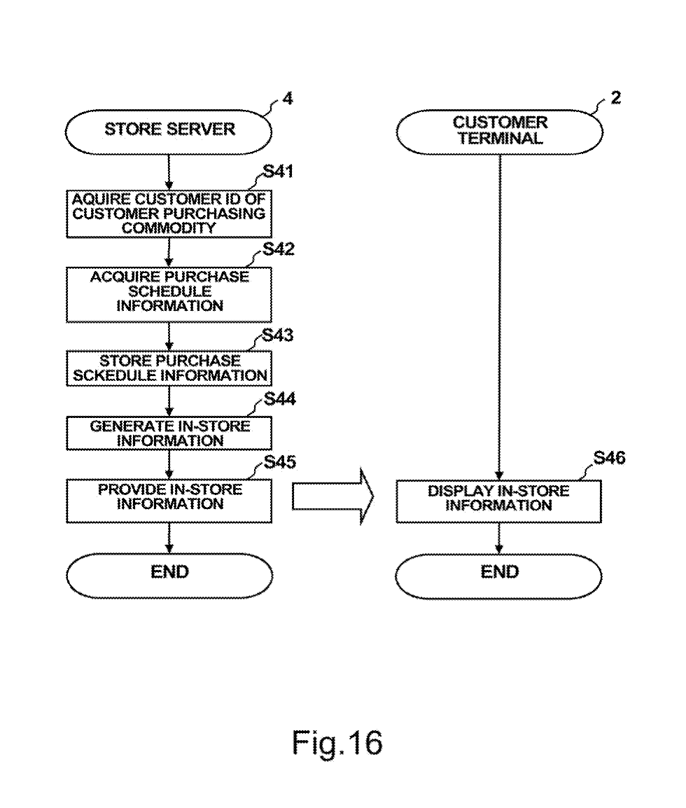

Hereinafter, a shopping support processing which is performed in a store will be described with reference to FIG. 16 to FIG. 18. FIG. 16 is a flow chart showing a shopping support processing. Regarding the shopping support processing, it is presupposed that a customer to visit a store brings the customer terminal 2 in which the own customer ID is held.

As shown in FIG. 16, a processing step S41 of the store server 4, the customer ID acquisition processor 414 of the store server 4 acquires the customer ID from the customer terminal 2 of a customer visiting the store, via a communication device (not shown) in the store connected to the store server 4. The class and installation position of the above-described communication device in not particularly limited. For example, the customer ID acquisition processor 414 acquires the customer ID from the customer terminal 2, via the near field communication device such as an NFC provided at an entrance of the store or an entrance of a parking lot, or the like. Furthermore, the customer ID acquisition processor 414 may acquire the customer ID from the customer terminal 2, via an access point which provides public wireless LAN service and so on in the store.

When the customer ID acquisition processor 414 acquires the custom ID, the processing of the shopping support system 1 proceeds to a processing step S42 of the store server 4. In the step S42, the purchase schedule acquisition processor 415 of the store server 3 acquires the purchase schedule information corresponding to the custom ID acquired by the customer ID acquisition processor 414. The acquisition destination of the purchase schedule information may be made to be the customer terminal 2, or may be made to be the center server 3. For example, when the store server 4 acquires the purchase schedule information from the customer terminal 2, the purchase schedule acquisition processor 415 acquires the purchase schedule information from the customer terminal 2, via the same communication device as that at the time of acquisition of the above described customer ID. Furthermore, when the store server acquires the purchase schedule information from the center server 3, the purchase schedule acquisition processor 415 acquires the purchase schedule information corresponding to the above-described acquired custom ID (refer to the step S41), from the shopping list management table T2 of the center server 3, via the communication I/F 44

When the purchase schedule acquisition processor 415 acquires the above-described purchase schedule information, the processing of the shopping support system 1 proceeds to a processing step S43 of the store server 4. In the step S43, the purchase schedule acquisition processor 415 of the store server stores the above-described acquired purchase schedule information, corresponding to the above-described acquired customer ID, and the current date and time (visiting date and time of a customer), using the purchase commodity management table T5 of the storage unit 45. For example, the purchase schedule acquisition processor 415 controls the storage operation of the storage unit 45, so as to store the above-described acquired purchase schedule information, using the storage unit 45. The purchase commodity management table T5 of the storage unit 45 stores the above-described acquired purchase schedule information corresponding to the above-described acquired customer ID, the current date and time (visiting date and time of a customer).

When the purchase schedule acquisition processor 415 stores the above-described acquired purchase schedule information, using the purchase commodity management table T5, the processing of the shopping support system 1 proceeds to a processing step S44 of the store server 4. In the step S44, the in-store information provision processor 416 of the store server 4 generates in-store information including the advertisement information for advertising a specific commodity and shopping support information for shopping support, and so on. When the in-store information provision processor 416 generates the in-store information, the processing of the shopping support system 1 proceeds to a processing step S45 of the store server 4. In the step S45, the in-store information provision processor 416 provides the customer terminal 2 of the above acquired custom ID (refer to the step S41) with the above-described created in-store information. For example, the in-store information provision processor 416 transmits the in-store information to the customer terminal 2, via the same communication device as that at the time of acquisition of the above-described customer ID.

In the above-described step S45, the advertisement information and the shopping support information included in the in-store information which the in-store information provision processor 416 provides to the customer terminal 2 may be generated based on the purchase schedule information (refer to the step S42) which the purchase schedule acquisition processor 415 has acquired. For example, the in-store information provision processor 416 generates advertisement information for advertising each of the candidate commodities included in the above acquired purchase schedule information (refer to the step S42). In addition, the in-store information provision processor 416 generates shopping support information indicating at what place the candidate commodity included in the above acquired purchase schedule information (refer to the step S42) is sold in the store. Specifically, the in-store information provision processor 416 has map information which records the selling positions of the respective commodities sold in the store, for example. The in-store information provision processor 416 specifies the selling positions of the candidate commodities included in the above acquired purchase schedule information (refer to the step S42), based on this map information. The in-store information provision processor 416 specifies the selling positions, to generate map information which records the selling positions of the candidate commodities included in the above acquired purchase schedule information (refer to the step S42), as the shopping support information

Information to be included in the in-store information is not limited to the above-described example. For example, when privilege such as point imparting is imparted under condition of visiting a store of a customer, the in-store information provision processor 416 includes an electronic coupon to instruct to impart the privilege in the in-store information.

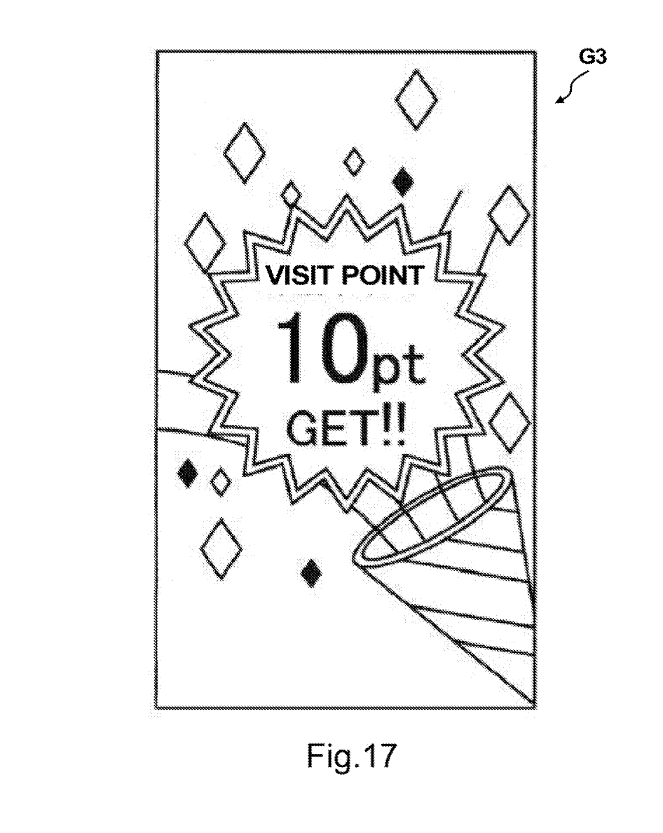

When the in-store information provision processor 416 transmits the above-described in-store information to the customer terminal 2, the processing of the shopping support system 1 proceeds to a processing step S46 of the customer terminal 2. In the step S46, when receiving the in-store information from the store server 4, the shopping support processor 212 of the customer terminal 2 displays the above-described in-store information, using the display 23, according to a customer's operation and so on. For example, the shopping support processor 212 controls the display operation of the display 23, so as to display the above-described in-store information, using the display 23. The display 23 is controlled by the shopping support server 212, to display the above-described in-store information. In addition, when the above-described electronic coupon is included in the shopping support information, for example, the display 23 is controlled by the shopping support processor 212, to display a privilege imparting screen G3 in accordance with the content of the above-described electronic coupon. FIG. 17 is a diagram showing an example of the privilege imparting screen G3. The display 23 displays the privilege imparting screen G3 shown in FIG. 17 in the second area A2 of the shopping guide screen G100 (refer to FIG. 14). The privilege imparting screen G3 displays a character string of “VISIT POINT 10 pt GET” as shown in FIG. 17, as a message for indicating that the point equivalent to 10 points has been imparted by visiting the store, for example.

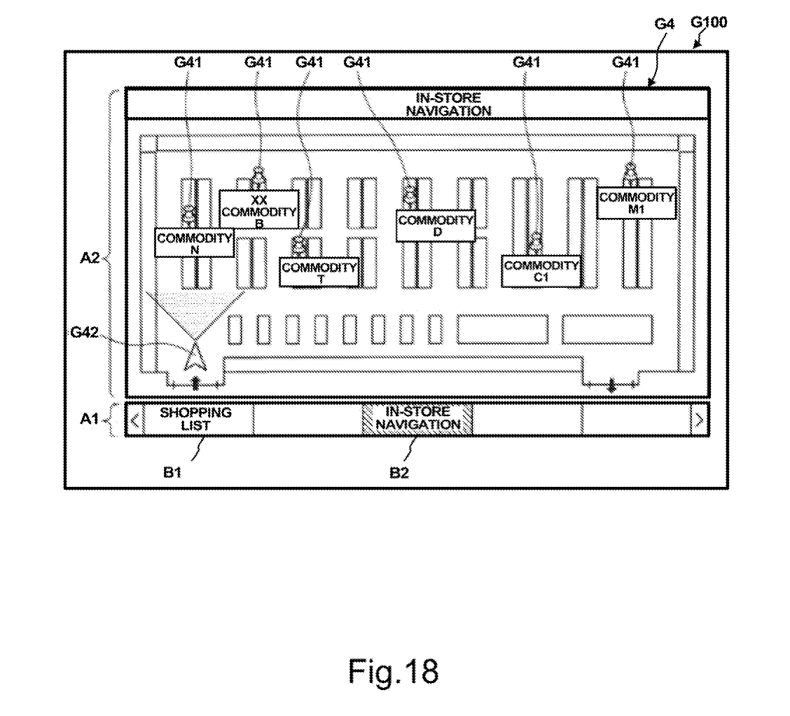

Furthermore, when in the in-store information, the above-described map information is included as the shopping support information, the shopping support processor 212 of the customer terminal 2, in accordance with the acceptance of a prescribed operation of a customer, displays the shopping support screen G4 (refer to FIG. 18) indicating selling positions of the candidate commodities included in the above acquired purchase schedule information (refer to the step S42), using the display 23. For example, when the button B2 which is displayed in the first area A1 of the shopping guide screen G100 (refer to FIG. 14) accepts a touch operation of the customer, the display 23 displays the shopping support screen G4.

FIG. 18 is a diagram showing an example of the shopping support screen G4. The display 23 displays the shopping support screen G4 in place of the shopping list screen G1 in the second area A2 of the shopping guide screen G100 (refer to FIG. 14), as shown in FIG. 18. The shopping support screen G4 includes a map image showing the inside of the store, as shown in FIG. 18. Furthermore, the shopping support screen G4 includes character strings indicating commodity names of the respective candidate commodities which are displayed on this map image, such as “COMMODITY N”, “XX COMMODITY B”, “COMMODITY T”, “COMMODITY D”, “COMMODITY C1” and “COMMODITY M1”. Furthermore, the shopping support screen G4 includes selling position icons G41 which are displayed along with the above-described commodity names, and show selling positions of the respective candidate commodities.

In addition, when it is possible to specify the current position and direction of the customer terminal 2 by the position specifying device and so on provided in the store, the shopping support screen G4 may include a current position icon G42 showing the current position of the own device (customer terminal 2) and the direction of the own device in the store, as shown in FIG. 18.

As described above, according to the shopping support processing, the shopping support system 1 can present the selling positions in the store of the candidate commodities included in the shopping list (purchase schedule information) to the customer, via the customer terminal 2. Accordingly, the shopping support system 1 can support the purchase of the candidate commodity in the store, and can improve the convenience of the customer relating to the shopping, and can achieve visiting promotion to the store.

In the step S42 of the above-described shopping support processing, the in-store information provision processor 416 acquires the purchase schedule information from the customer terminal 2, when the customer visits the store. Furthermore, in the step S43, the in-store information provision processor 416 stores the acquired purchase schedule information, using the purchase commodity management table T5 of the storage unit 45. On the other hand, the in-store information provision processor 416 may also acquire the additional information, and may store the acquired additional information, using the purchase commodity management table T5 of the storage unit 45. When storing the above-described additional information, the in-store information provision processor 416 can deal with the storing of the additional information, by adding a data area to store the additional information in the purchase commodity management table T5.

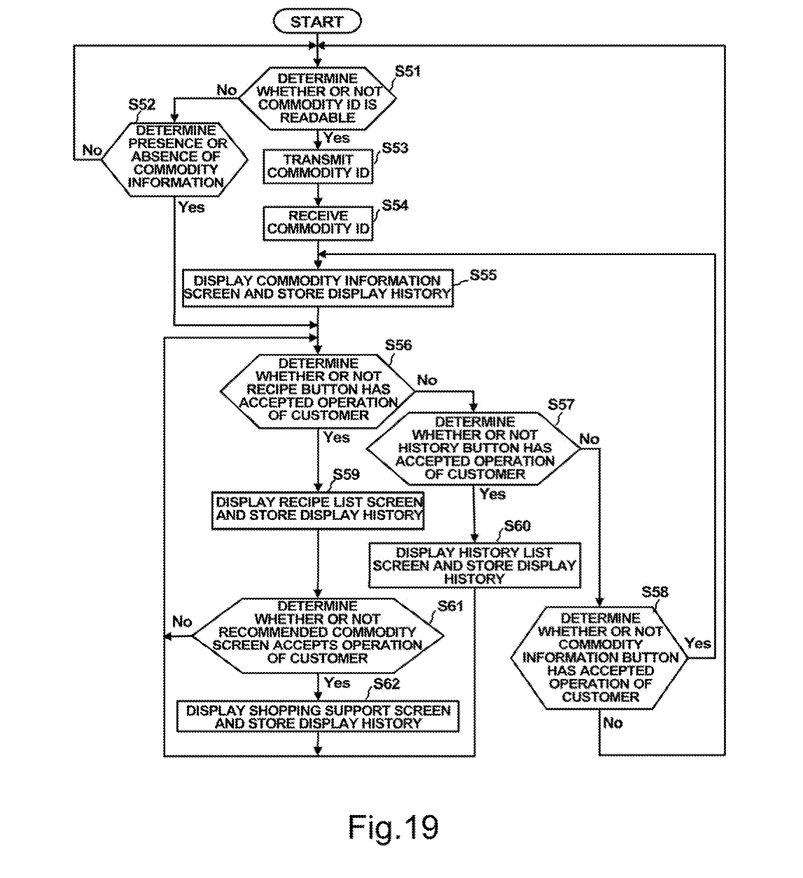

Hereinafter, a commodity selection support processing which the customer terminal 2 executes when a customer purchases a commodity using the customer terminal 2 will be described with reference to FIG. 19. FIG. 19 is a flow chart showing the commodity selection support processing which the customer terminal 2 executes.

When a customer purchases a commodity using the customer terminal 2, the customer holds the customer terminal 2 over the electronic shelf tag 6, for example. When the customer holds the customer terminal 2 over the electronic shelf tag 6, as shown in FIG. 19, in a processing step S51, the shopping support processor 212 of the customer terminal 2 performs information communication with the electronic shelf tag 6, so as to determine whether or not the above-described commodity ID that is the identification information of the commodity is readable from the commodity identification information storage table 66a, by the communication standard such as an NFC. Specifically, the shopping support processor 212 performs information communication with the electronic shelf tag 6, using the near field communication I/F 27. The shopping support processor 212 performs the information communication, to determine whether or not the commodity ID is readable from the commodity identification information storage table 66a of the electronic shelf tag 6.

In the above-described step S51, when the shopping support processor 212 determines that the commodity ID is not readable from the commodity identification information storage table 66a (No in the above-described step S51), the processing of the customer terminal 2 proceeds to a processing step S52. In the step S52, the shopping support processor 212 of the customer terminal 2 determines the presence or absence of the read commodity ID and the commodity information corresponding to this commodity ID which are previously stored, in the commodity reference table T1 of the storage unit 28. When the shopping support processor 212 determines that the commodity ID and the commodity information which are previously stored in the commodity reference table T1 are not present (No in the above-described step S52), the processing of the customer terminal 2 returns to the above-described step S51. On the other hand, in the above-described step S52, when the shopping support processor 212 determines that the commodity ID and the commodity information which are previously stored in the commodity reference table T1 are present (Yes in the above-described step S52), the processing of the customer terminal 2 proceeds to a processing step S56. When the commodity ID and the commodity information which are previously stored in the commodity reference table T1 are present, the shopping support processor 212 displays the commodity information stored in the commodity reference table T1, using the display 23. In other words, the display 23 displays the commodity information corresponding to the commodity ID stored in the commodity reference table T1, based on the control of the shopping support processor 212. Specifically, the display 23 displays the commodity information screen G5 described later, for example. The processing of the customer terminal 2 proceeds to the step S56, in the state where the display 23 maintains the screen which displays the commodity information.

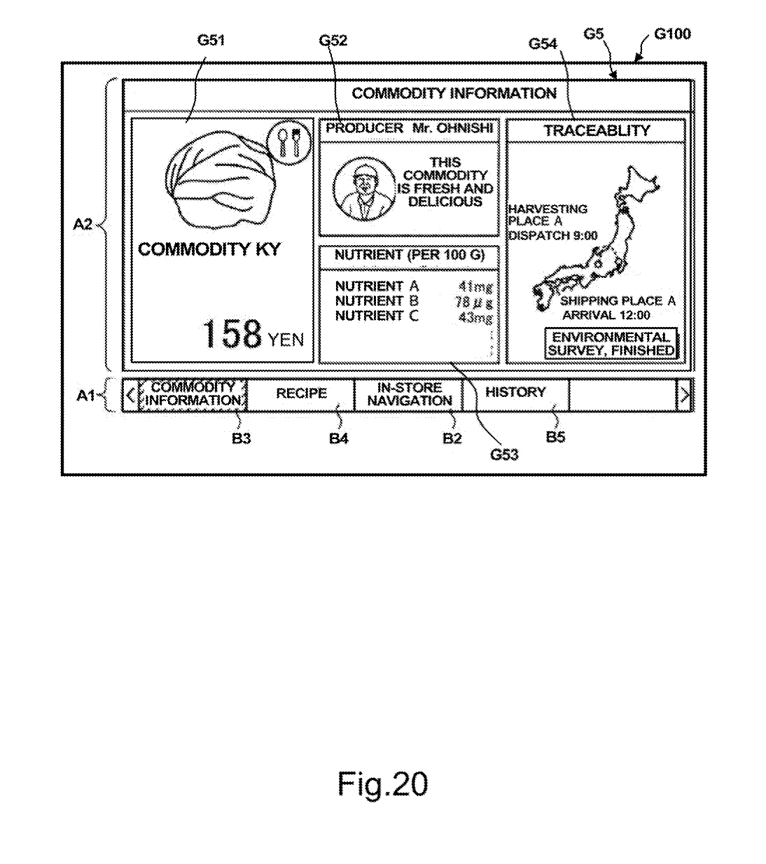

On the other hand, in the above-described step S51, when the shopping support processor 212 determines that the commodity ID is readable from the commodity identification information storage table 66a (Yes in the above-described step S51), the processing of the customer terminal 2 proceeds to a processing step S53. In the step S53, the shopping support processor 212 of the customer terminal 2 transmits the commodity ID to the store server 4, for example. Specifically, the shopping support processor 212 performs information communication with the electronic shelf tag 6, using the near field communication I/F 27, so as to read the commodity identification information including the commodity ID from the electronic shelf tag 6, for example. The shopping support processor 212 performs the information communication with the electronic shelf tag 6, using the near field communication I/F 27, to read the commodity ID stored in the commodity identification information storage table 66a of the electronic shelf tag 6, from the electronic shelf tag 6. More specifically, the near field communication I/F 27 receives the information including the commodity ID transmitted from the antenna 64 of the electronic shelf tag 6. The near field communication I/F 27 receives the information including the commodity ID, and thereby the shopping support processor 212 reads the information including the commodity ID from the electronic shelf tag 6. Furthermore, the shopping support processor 212 transmits the commodity ID read from the electronic shelf tag 6 to the store server 4, using the communication I/F 26. For example, the shopping support processor 212 controls the communication I/F 26, so as to transmit the commodity ID to the store server 4. The communication I/F 26 is controlled by the shopping support processor 212, to transmit the commodity ID to the store server 4. When the shopping support processor 212 transmits the commodity ID to the store server 4, the processing of the customer terminal 2 proceeds to a processing step S54. In the step S54, the shopping support processor 212 of the customer terminal 2 receives the commodity information which the store server 4 stores in the commodity management table T4, corresponding to the commodity ID, using the communication I/F 26. For example, the shopping support processor 212 of the customer terminal 2 controls the communication I/F 26, so as to receive the commodity information from the store server 4. The communication I/F 26 is controlled by the shopping support processor 212, to receive the commodity information from the store server 4. In addition, the shopping support processor 212 makes the commodity reference table T1 of the storage unit 28 store the commodity information received from the store server 4, corresponding to the commodity ID. For example, the shopping support processor 212 controls the storage unit 28, so as to store the commodity information received from the store server 4 in the commodity reference table T1. The commodity reference table T1 of the storage unit 28 is controlled by the shopping support processor 212, to store the commodity information received from the store server 4, corresponding to the commodity ID. When the shopping support processor 212 makes the storage unit 28 store the commodity information received from the store server 4, the processing of the customer terminal 2 proceeds to a processing step S55. In the step S55, the shopping support processor 212 of the customer terminal 2 makes the commodity information which is received from the store server 4 and stored in the commodity reference table T1 of the storage unit 28 to be displayed in the commodity information screen G5 (refer to FIG. 20). For example, the shopping support processor 212 controls the display operation of the display 23, so as to make the display 23 display the commodity information screen G5. The display 23 is controlled by the shopping support processor 212, to display the commodity information screen G5. In addition, the history creation processor 213 makes the commodity reference table T1 store that the display 23 has displayed the commodity information screen G5, as the above-described reference information. For example, the history creation processor 213 controls the storage unit 28, so as to make the commodity reference table T1 store that the display 23 has displayed the commodity information screen G5, as the above-described reference information. The commodity reference table T1 of the storage unit 28 is controlled by the history creation processor 213, to store the display time period and time instant, and the number of display times of the commodity information screen G5, as the above-described reference information. In the above-described step S55, the commodity information which the shopping support processor 212 makes to be displayed in the commodity information screen G5 of the display 23 is not limited to the commodity information which is received from the store server 4 and stored in the storage unit 28. The commodity information which the shopping support processor 212 makes to be displayed in the commodity information screen G5 of the display 23 may be the commodity information which is stored in the commodity identification information storage table 66a of the electronic shelf tag 6, corresponding to the commodity ID.

In the above-described step S55, the commodity information screen G5 which the shopping support processor 212 makes the display 23 display will be described with reference to FIG. 20. FIG. 20 is a diagram showing an example of the shopping information screen G5. As shown in FIG. 20, the shopping support processor 212 makes the commodity information screen G5 to be displayed in the second area A2 of the shopping guide screen G100. In addition, the shopping support processor 212 makes operators to be displayed in the first area A1 of the shopping guide screen G100, so as to switch the display screen of the second area A2 to various screens.

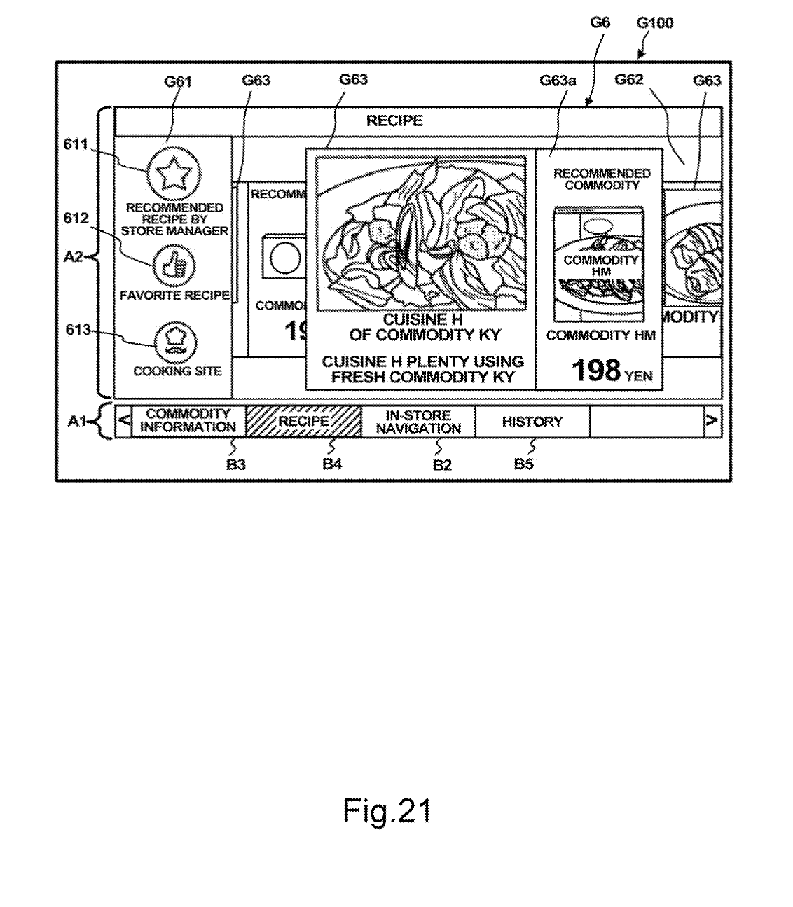

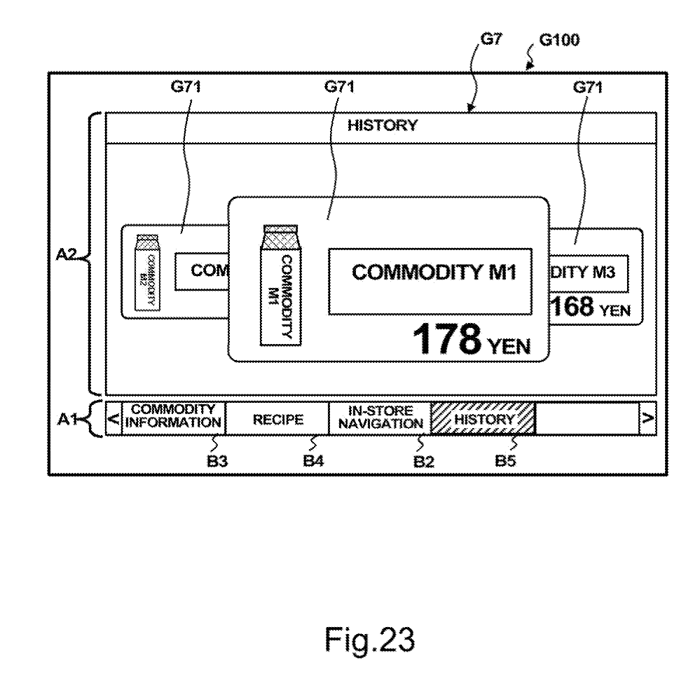

In FIG. 20, the operators displayed in the first area A1 include a commodity information button B3, a recipe button B4, a history button B5, and the above-described in-house navigation button B2. In the display state of the first area A1 of FIG. 20, the above-described shopping list button B1 conceals itself. The recipe button B4 is an operator to accept a touch operation of a customer, so as to switch the screen to be displayed in the above-described area A2 to the recipe list screen G6 (refer to FIG. 21). In the button B4, a character string of “RECIPE”, for example, is displayed, so as to guide the function of the button to a customer. The recipe list screen G6 displays recipe information of a cuisine using a commodity whose commodity information is displayed in the commodity information screen G5. The history button B5 is an operator to accept a touch operation of a customer, so as to switch the screen to be displayed in the above-described area A2 to a history list screen G7 (refer to FIG. 23). In the button B5, a character string of “HISTORY”, for example, is displayed, so as to guide the function of the button to a customer. The history list screen G7 displays commodity information which the customer terminal 2 carried by a customer during shopping has read from the electronic shelf tag 6, side by side as described later. The commodity information button B3 is an operator to accept a touch operation of a customer, so as to switch the above-described screen to be displayed in the above-described area A2 to the commodity information screen G5. In the button B3, a character string of “COMMODITY INFORMATION”, for example, is displayed, so as to guide the function of the button to a customer.

In FIG. 20, the second area A2 displays the commodity information screen G5. The display content of the commodity information screen G5 includes commodity information of the commodity corresponding to the commodity ID stored in the commodity identification information storage table 66a, for example. Specifically, as shown in FIG. 20, the commodity information includes information G51 of a commodity name and a price of the commodity, producer information G52, nutrient information G53, and traceablity information G54 and so on. The commodity information screen G5 displays a character string of “COMMODITY KY”, for example, indicating the commodity name, as the information 51 of the commodity name. The producer information G52 includes a name of a producer, a face picture of the producer, and a message of the producer. The commodity information screen G5 displays a character string of “PRODUCER Mr. OHNISHI”, for example, indicating the name of the producer, and a character string of “THIS COMMODITY IS FRESH AND DELICIOUS”, for example, indicating the message of the producer, as the producer information G52. The nutrient information G3 includes information relating to the amount of nutrient contained in the commodity. The commodity information screen G5 displays a character string of “NUTRIENT (PER 100 g)”, for example, indicating the nutrient of the commodity, the content of a nutrient A (41 mg), the content of a nutrient B (78 μg), and the content of a nutrient C (43 mg), as the nutrient information G53. The traceability information G54 includes information of a harvesting place of the commodity, information of a dispatch time from the harvesting place, information of a shipping place, and information of an arrival time to the shipping place. The traceability information G54 further includes information such as the presence or absence of environmental survey of the shipping place. The commodity information screen G5 displays a character string of “HARVESTING PLACE A”, for example, indicating the harvesting place of the commodity, a character string of “DISPATCH 9:00”, for example, indicating the dispatch time, a character string of “SHIPPING PLACE A”, for example, indicating the shipping place, a character string of “ARRIVAL 12:00”, for example, indicating the arrival time, and a character string of “ENVIRONMENTAL SURVEY, FINISHED” indicating the presence or absence of the environmental survey, as the traceability information G54. FIG. 20 is an example of the commodity information screen G5 which displays the commodity information of the commodity of the commodity name “COMMODITY KY”.

In the above-described step S55, when the shopping support processor 212 makes the display 23 display the commodity information screen G5 shown in FIG. 20, the processing of the customer terminal 2 proceeds to a processing step S56. In the step S56, the shopping support processor 212 of the customer terminal 2 determines whether or not the recipe button B4 has accepted a touch operation by a customer. When the shopping support processor 212 determines that the recipe button B4 has accepted the touch operation by the customer (Yes in the above-described step S56), the processing of the customer terminal 2 proceeds to a processing step S59. In the step S59, the shopping support processor 212 makes the display 23 display the recipe list screen G6 described later. For example, the shopping support processor 212 controls the display operation of the display 23, so as to make the display 23 display the recipe list screen G6. The display 23 is controlled by the shopping support processor 212, to display the recipe list screen G6. In addition, the history creation processor 213 makes the commodity reference table T1 store that the display 23 has displayed the recipe list screen G6, as the above-described reference information. For example, the history creation processor 213 controls the storage unit 28, so as to make the commodity reference table T1 store that the display 23 has displayed the recipe list screen G6, as the above-described reference information. The commodity reference table T1 of the storage unit 28 is controlled by the history creation processor 213, to store the display time period and time instant, and the number of display times of the recipe list screen G6, as the above-described reference information.

In the above-described step S59, the recipe list screen G6 which the shopping support processor 212 makes the display 23 display will be described with reference to FIG. 21. FIG. 21 is a diagram showing an example of the recipe list screen G6. As shown in FIG. 21, the shopping support processor 212 makes the above-described buttons B2-B5 to be displayed in the first area A1 of the shopping guide screen G100, and makes the recipe list screen G6 of the display 23 to be displayed in the second area A2. The display content of the recipe list screen G6 includes a recipe collection selection screen G61 and a recipe selection screen G62. The recipe collection selection screen G61 is a screen to accept a touch operation of a customer, so that the customer selects a desired recipe from a recipe collection in which a plurality of recipes are stored. The recipe collection includes a first recipe collection to store recipes which the store recommends, a second recipe collection to store favorite recipes of the customer oneself, and a third recipe collection to store recipes which are posted on a cooking site. The information relating to the first to third recipe collections is included in the above-described commodity information stored in the commodity reference table T1, for example. The recipe collection selection screen G61 displays a recipe icon 611 to accept a touch operation by a customer so as to select the first recipe collection, a recipe icon 612 to accept a touch operation by a customer so as to select the second recipe collection, and a recipe icon 613 to accept a touch operation by a customer so as to select the third recipe collection. The recipe collection selection screen G61 displays a character string of “RECOMMENDED RECIPE BY STORE MANAGER”, for example, so as to guide the function of the recipe icon 611 to a customer. The recipe collection selection screen G61 displays a character string of “FAVORITE RECIPE”, for example, so as to guide the function of the recipe icon 612 to a customer. The recipe collection selection screen G61 displays a character string of “COOKING SITE”, for example, so as to guide the function of the recipe icon 613 to a customer. The recipe selection screen G62 is a screen to display a recipe included in the recipe collection selected by the customer, using the recipe collection screen G61.

As shown in FIG. 21, the recipe selection screen G62 includes one or more recipe screens G63. The recipe selection screen G62 of FIG. 21 displays a plurality of the recipe screens G63 superposedly. The recipe screen G63 accepts a touch operation by a customer. The recipe screen G63 is a screen to display a recipe of the displayed cuisine, by accepting the touch operation of the customer. The recipe screen G3 displayed on the forefront of FIG. 21 is a display state before accepting the touch operation by the customer. The recipe screen G63 in this display state displays the image of the cuisine, the name of the cuisine, and the explanation of the cuisine. The recipe screen G63 of FIG. 21 displays a character string of “CUISINE H OF COMMODITY KY”, for example, as the cuisine name, and a character string of “CUISINE H PLENTY USING FRESH COMMODITY KY” for example, as the explanation of the cuisine. Furthermore, the recipe screen G63 includes a recommended commodity screen G63a. The recommended commodity screen G63a is a screen to display a commodity (hereinafter simply called a recommended commodity) which is a commodity used in a recipe at the time of creating the cuisine (the above-described “CUISINE H”, for example) displayed in the recipe screen G63, and also is a commodity which the store recommends its use. The recommended commodity screen G63a contained in the recipe screen G63 on the forefront of FIG. 21 displays the image of the commodity, a character string of “COMMODITY HM”, for example, indicating the commodity name, and a price (unit price, for example) of the commodity, as the above-described recommended commodity.

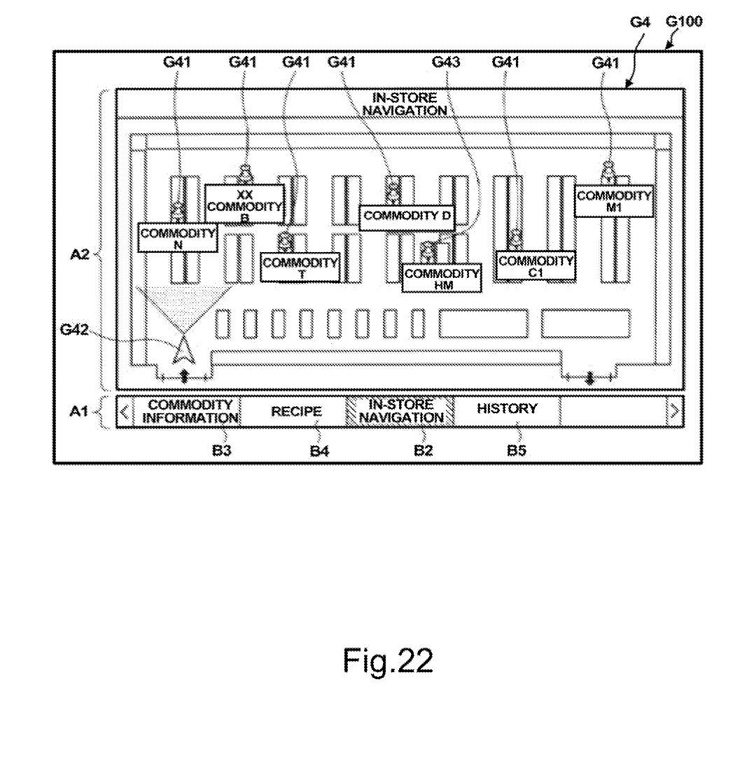

The recipe screen G63 accepts a touch operation by a customer, and thereby can move from side to side, for example, in the recipe selection screen G62. The recipe selection screen G62 can make other recipe screen G63 to be displayed on the front, in accordance with the movement of the recipe screen G63. Accordingly, the customer can select a desired recipe to be displayed in the recipe screen, out of one or more recipe screens. Furthermore, when accepting a touch operation of a customer, the recommended commodity screen G63a switches to the shopping support screen G4 (refer to FIG. 22) which notifies the place where the recommended commodity displayed in the recommended commodity screen G63a is placed. In other words, when the recommended commodity screen G63a accepts a touch operation of a customer, the display 23 displays the shopping support screen G4 which notifies the place where the recommended commodity is placed, in the second area A2 of the shopping guide screen G100. FIG. 22 is a diagram showing an example of the shopping support screen G4 added with the recommended commodity. The shopping support screen G4 of FIG. 22 displays a recommendation icon G43, in addition to the above-described icons G41, G42. The recommendation icon G43 is an icon to show the selling position of the above-described recommended commodity. The shopping support screen G4 of FIG. 22 displays a character string of “COMMODITY HM”, for example, indicating the commodity name of the recommended commodity, at the position near the display position of the recommendation icon G43, so as to guide the customer that the recommendation icon G43 is an icon which indicates the selling position of the above-described recommended commodity. The customer terminal 2 makes the display 23 display the shopping support screen G4 of FIG. 22, to guide the customer to the selling position of the recommended commodity.

In the above-described step S59, when the shopping support processor 212 makes the display 23 display the recipe list screen G6, as described above, the processing of the customer terminal 2 proceeds to a processing step S61. In the step S61, the shopping support processor 212 of the customer terminal 2 determines whether or not the above-described recommended commodity screen G63a has accepted a touch operation of a customer. When the shopping support processor 212 determines that the recommended commodity screen G63a has accepted the touch operation of the customer (Yes in the above-described step S61), the processing of the customer terminal 2 proceeds to a processing step S62. In the step S62, the shopping support processor 212 of the customer terminal 2 makes the display 23 display the shopping support screen G4 of FIG. 22 added with the recommended commodity. Furthermore, the history creation processor 213 makes the commodity reference table T1 store that the display 23 has displayed the shopping support screen G4, as the above-described reference information. For example, the history creation processor 213 controls the storage unit 28, so as to make the commodity reference table T1 store that the display 23 has displayed the shopping support screen G4, as the above-described reference information. The commodity reference table T1 of the storage unit 28 is controlled by the history creation processor 213, to store the display time period and time instant, and the number of the display times of the shopping support screen G4, as the above-described reference information. When the history creation processor 213 makes the commodity reference table T1 store that the display 23 has displayed the shopping support screen G4, as the above-described reference information, the processing of the customer terminal 2 returns to the above-described step S56.

In the above-described step S56, when the shopping support processor 212 determines that the recipe button B4 has not accepted a touch operation of a customer (No in the above-described step S56), the processing of the customer terminal 2 proceeds to a processing step S57. In the step S57, the shopping support processor 212 of the customer terminal 2 determines whether or not the history button B5 has accepted a touch operation of a customer. When the shopping support processor 212 determines that the history button B5 has accepted the touch operation of the customer (Yes in the above-described step S57), the processing of the customer terminal 2 proceeds to a processing step S60. In the step S60, the shopping support processor 212 of the customer terminal 2 makes the display G23 display a history list screen G7 (refer to FIG. 23). Furthermore, the shopping support processor 212 makes the commodity reference table T1 store that the display 23 has displayed the history list screen G7, as the above-described reference information. For example, the history creation processor 213 controls the storage unit 28, so as to make the commodity reference table T1 store that the display 23 has displayed the history list screen G7, as the above-described reference information. The commodity reference table T1 of the storage unit 28 is controlled by the history creation processor 213, to store the display time period and time instant, and the number of display times of the history list screen G7, as the above-described reference information. When the history creation processor 213 makes the commodity reference table T1 store that the display 23 has displayed the history list screen G7, as the above-described reference information, the processing of the customer terminal 2 returns to the above-described step S56.

In the above-described step S60, the history list screen G7 which the shopping support processor 212 makes the display 23 display will be described with reference to FIG. 23. FIG. 23 is a diagram showing an example of the history list screen G7. As shown in FIG. 23, the display 23 displays the above-described buttons B2-B5 in the first area A1 of the shopping guide screen G100. In addition, the display 23 displays the history list screen G7 in the second area A2 of the shopping guide screen G100. The display content of the history list screen G7 to be displayed in the second area A2 of the shopping guide screen G100 includes commodity information stored in the storage unit 28 of the customer terminal 2, after the customer enters the store. The history list screen G7 displays one or more commodity information side by side. The history list screen G7 displays the above-described commodity information side by side, and thereby shows the history that the commodity information stored in the storage unit 28 has been referred to.

Specifically, the history list screen G7 of the second area A2 displays one or more commodity reference screens G71 indicating the commodity information stored in the storage unit of the customer terminal 2 after the customer enters the store, side by side. The commodity information stored in the storage unit 28 of the customer terminal 2 after the customer enters the store is the commodity ID which the customer terminal 2 has read from the electronic shelf tag 6 and the commodity information corresponding to this commodity ID (refer to the above-described step S53). When displaying the commodity reference screens G71, the history list screen G7 displays the commodity reference screens G71 in such an order that the customer terminal 2 has read the commodity IDs from the above-described electronic shelf tags 6. For example, the history list screen G7 of FIG. 23 displays the commodity reference screens G71 in order, while the commodity reference screen G71 showing the commodity information which has been read most recently is displayed on the forefront. In addition, the commodity reference screen G71 can move from side to side, for example, in the history list screen G7, by accepting a touch operation of a customer. The history list screen G7 can make other commodity reference screen G71 to be displayed on the front, in accordance with the movement of the commodity reference screen G71. Accordingly, the customer can see the whole history of the above-described referred commodity information, by moving the commodity reference screen G71 in the history list screen G7.

The commodity reference screen G71 displays an image of a commodity, a commodity name and a price of the commodity (a unit price, for example), as shown in FIG. 23. The commodity reference screen G71 on the forefront displays an image of a commodity of a commodity name “COMMODITY M1”, a character string of “COMMODITY M1”, for example, indicating the commodity name, and a unit price of the commodity of the commodity name “COMMODITY M1”. The display content of the commodity reference screen G71 may include commodity information other than the commodity name and the unit price of the commodity. For example, the display content of the commodity reference screen G71 may be the display content of the above-described commodity information screen G5. In addition, the history list screen G7 may display the above-described commodity information screen G5, as the commodity reference screen G71. The alignment order of displaying the commodity reference screens G71 may be an optional alignment order. The alignment order of displaying the commodity reference screens G71 may be a Japanese alphabetical order of the commodity name, an ascending order or descending order of the price of the commodity. In addition, the alignment order of displaying the commodity reference screens G71 may be an alignment order for each commodity classification. The history list screen G7 of FIG. 23 displays the commodity reference screen G71 for each commodity classification. Specifically, the history list screen G7 displays the commodity reference screens G71 indicating the commodity information of the commodities whose common names are included in the commodity classification of “COMMODITY M”, such as the commodities whose concrete names are “COMMODITY M1”, “COMMODITY M2” and “COMMODITY M3”. Accordingly, the customer rearranges the alignment order of displaying the commodity reference screens G71 into an optional order, in the history list screen G7, and thereby becomes possible to compare the commodity information of the commodities side by side.

On the other hand, when the shopping support processor 212 of the customer terminal 2 determines that the history button B5 has not accepted a touch operation of a customer (No in the above-described step S57), the processing of the customer terminal 2 proceeds to a processing step S58. In the step S58, the shopping support processor 212 of the customer terminal 2 determines whether or not the commodity information button B3 has accepted a touch operation of a customer. When the shopping support processor 212 determines that the commodity information button B3 has accepted the touch operation of the customer (Yes in the above-described step S58), the processing of the customer terminal 2 returns to the above-described step S55. In the step S55, the shopping support processor 212 of the customer terminal 2 makes the display 23 display the commodity information screen G5, as described above. On the other hand, when the shopping support processor 212 determines that the commodity information button B3 has not accepted the touch operation of the customer (No in the above-described step S58), the processing of the customer terminal 2 returns to the above-described step S51.

As described above, the customer terminal 2 displays various screens, to support the commodity selection of the customer. Furthermore, the customer terminal 2 stores the above-described reference information regarding the displayed screen, to create history of the referred commodity information.

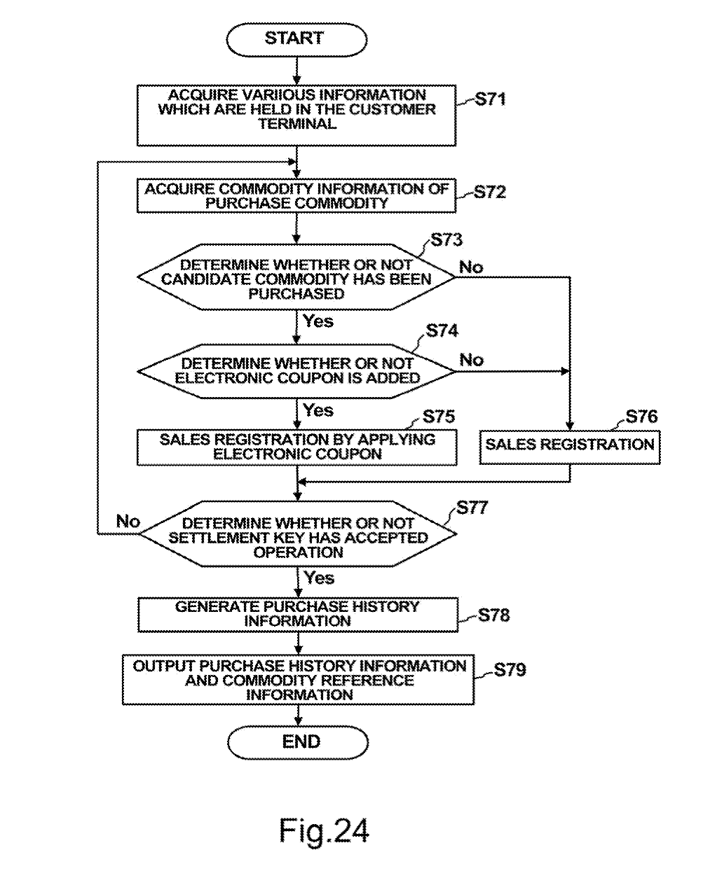

Hereinafter, commodity sales data processing which the POS terminal 5 of the shopping support system 1 performs when a customer purchases a commodity will be described with reference to FIG. 24. FIG. 24 is a flow chart showing the commodity sales data processing.

As shown in FIG. 24, in a step S71, the terminal information acquisition processor 511 of the POS terminal 5 acquires the customer ID, the commodity reference information, the purchase schedule information and the additional information which are held in the customer terminal 2, from the customer terminal 2. A method of acquiring the customer ID, the commodity reference information, the purchase schedule information and the additional information by the terminal information acquisition processor 511 is not limited. For example, the terminal information acquisition processor 511 may directly acquire the customer ID, the purchase schedule information and the additional information from the customer terminal 2, using the near field communication I/F 57. Furthermore, the terminal information acquisition processor 511 may acquire the purchase schedule information and the additional information which are stored corresponding to the customer ID, from the purchase commodity management table T5 of the storage unit 45, using the customer ID acquired from the customer terminal 2 as a search fee.

When the terminal information acquisition processor 511 acquires the customer ID, the purchase schedule information and the additional information, the processing of the POS terminal 5 proceeds to a processing step S72. In the step S72, the commodity information acquisition processor 512 of the POS terminal 5 acquires commodity information of an actual purchase commodity. For example, the commodity information acquisition processor 512 controls the read operation of the code scanner 55, so as to acquire the commodity information of the purchase commodity, using the code scanner 55. The code scanner 55 scans the actual purchase commodity, to read the commodity ID attached to the purchase commodity. The commodity information acquisition processor 512 acquires the commodity information stored corresponding to the above read commodity ID, from the commodity management table T4. The commodity information includes a commodity name and a unit price and so on of the purchase commodity.

When the commodity information acquisition processor 512 acquires the commodity information of the purchase commodity, the processing of the POS terminal 5 proceeds to a processing step S73. In the step S73, the sales registration processor 513 of the POS terminal 5 determines whether or not the candidate commodity included in the shopping list has been purchased. Specifically, the sales registration processor 513 compares the commodity names of the purchase commodity included in the above acquired commodity information with the commodity names of the candidate commodity included in the shopping list, respectively. The sales registration processor 513 determines, based on this comparison result, whether or not the commodity name of the purchase commodity included in the above acquired commodity information coincides with the commodity name of the candidate commodity included in the shopping list. When the sales registration processor 513 determines that the commodity other than the candidate commodity has been purchased (No in Step S73), the processing of the POS terminal 5 proceeds to a processing step S76. In the step S76, the sales registration processor 513 performs sales registration of the purchase commodity, based on the acquired commodity information.

When the sales registration processor 513 determines that the candidate commodity has been purchased, in the above-described step S73 (Yes in step S73), the processing of the POS terminal 5 proceeds to a step S74. In the step S74, the sales registration processor 513 determines whether or not the electronic coupon which is provided from the own store is added to the above purchased candidate commodity, as the additional information. For example, the sales registration processor 513 determines whether or not the electronic coupon is added to the above purchased candidate commodity, with reference to the above acquired additional information (refer to the step S71). When the sales registration processor 513 determines that the electronic coupon is added to the above purchased candidate commodity (Yes in step S74), the processing of the POS terminal 5 proceeds to a processing step S75. In the step S75, the sales registration processor 513 performs sales registration of the purchase commodity at a unit price applied with the above-described electronic coupon. When the sales registration processor 513 determines that the electronic coupon is not added to the above purchased candidate commodity (No in step S74), the processing of the POS terminal 5 proceeds to a processing step S76. In the step S76, the sales registration processor 513 performs sales registration of the purchase commodity at a usual unit price included in the commodity information.

When the sales registration processor 513 performs sales registration in the above-described step S75 or the above-described step S76, the processing of the POS terminal 5 proceeds to a processing step S77. In the step S77, the controller 51 of the POS terminal 5 determines whether or not the settlement key of the operation panel 42 has accepted an operation of a store employee. When the controller 51 determines that the settlement key of the operation panel 42 has not accepted the operation of the store employee (No in step S77), the processing of the POS terminal 5 returns to the above-described step S72. The POS terminal 5 repeatedly executes the processings of the above-described step S72—the above-described step S76, till the controller 51 determines that the settlement key of the operation panel 42 has accepted the operation of the store employee. When the controller 51 determines that the settlement key of the operation panel 42 has accepted the operation of the store employee (Yes in Step S77), the processing of the POS terminal 5 proceeds to a processing step S78. In the step S78, the purchase history generation processor 514 of the POS terminal 5 generates purchase history information showing items of transaction in which sales registration for the whole purchase commodities has been finished. The purchase history information includes a commodity name, a commodity ID and a unit price and so on of the purchase commodity

When the purchase history generation processor 514 generates the purchase history information, the processing of the POS terminal 5 proceeds to a processing step S79. In the step S79, the purchase history output processor 515 of the POS terminal 5 outputs the above generated purchase history information and the commodity reference information. Specifically, the purchase history output processor 515 adds the corresponding customer ID to the above generated purchase history information and the commodity reference information. The purchase history output processor 515 transmits the purchase history information and the commodity reference information added with the customer ID to the store server 4, using the communication I/F 56. For example, the purchase history output processor 515 controls the communication operation of the communication I/F 56, so as to transmit the above generated purchase history information and the commodity reference information to the store server 4, using the communication I/F 56. The communication I/F 56 is controlled by the purchase history output processor 515, to transmit the purchase history information and the commodity reference information added with the customer ID to the store server 4. In addition, the purchase history output processor 515 controls the printing operation of the printer 54, so as to print a receipt based on the above generated purchase history information, using the printer 54. The printer 54 prints the receipt, based on the above generated purchase history information. The purchase history output processor 515 may transmit the purchase history information to the customer terminal 2, using the communication I/F 56, in place of print output of the receipt.

As described above, according to the commodity sales data processing, the shopping support system 1 can apply the electronic coupon which has been provided from the store at the time of creating the shopping list, when a customer purchases the candidate commodity. Accordingly, the customer who purchases the candidate commodity can enjoy the privilege provided at the time of creating the shopping list, without any consideration. Furthermore, the shopping support system 1 can prevent the customer from forgetting to use the electronic coupon. Furthermore, the shopping support system 1 can improve the convenience relating to the purchase of the candidate commodity.

Furthermore, the store server 4 to which the commodity reference information has been transmitted from the POS terminal 5 compares the commodity reference information with the purchase history information, and thereby can grasp the commodity whose commodity information has been referred to but which has not come to be purchased. Accordingly, the store analyzes regarding whether there is a problem in the traceability information, or whether there is a problem in the commodity arrangement in the store, and thereby can make use of the result of the analysis for commodity development and store operation.

As described above, according to the first embodiment, the customer terminal 2 reads the identification information to identify the commodity from the electronic shelf tag 6. Furthermore, the customer terminal 2 transmits the read identification information to the store server 4. The store server 4 transmits the commodity information having the same identification information as the identification information transmitted from the customer terminal 2, to the customer terminal 2. The customer terminal 2 makes the storage unit 28 store the commodity information transmitted from the store server 4. Furthermore, the customer terminal 2 makes the display 23 display the commodity information transmitted from the store server 4. Accordingly, when judging whether or not to purchase the commodity, a customer can browse the commodity information displayed on the portable terminal of the customer. Accordingly, the shopping support using a portable terminal can be improved.

According to the first embodiment, the POS terminal 5 transmits the commodity reference information including the reference information that is the history which has referred to the commodity information, to the store server 4. However, the transmission destination of the commodity reference information by the POS terminal 5 is not limited to the store server 4. For example, the transmission destination of the commodity reference information by the POS terminal 5 may be the center server 3. Furthermore, for example, the transmission destination of the commodity reference information by the POS terminal 5 may be the customer terminal 2. The POS terminal 5 transmits the commodity reference information including the above-described reference information to the customer terminal 2, and thereby the customer becomes able to browse the reference history of the commodity information from the customer terminal 2. Accordingly, the customer can make use of the referred commodity information for the document and so on for planning the next shopping.

Furthermore, according to the first embodiment, the customer terminal 2 reads the identification information (commodity ID) of the commodity from the electronic shelf tag 6. However an object from which the customer terminal 2 reads the commodity ID is not limited to the electronic shelf tag 6. For example, the customer terminal 2 may read the commodity ID from an RFID tag attached to the commodity, or a signage terminal and so on to display the commodity.

In addition, according to the first embodiment, the customer terminal 2 makes the display 23 display the commodity information screen G5 using the commodity information. In other words, the commodity information screen G5 of the display 23 displays the commodity information. However, the commodity information screen G5 may display the information which has been registered in advance, other than the commodity information. For example, when the customer terminal 2 reads the commodity identification information of the commodity included in the purchase schedule information, the commodity information screen G5 may display that the commodity corresponding to the read commodity identification information is a commodity included in the purchase schedule information, in such a manner that the customer can identify it. Specifically, the customer terminal 2 compares the information such as the commodity ID and the commodity name (general common name such as category name, for example) which the customer terminal 2 has stored as the purchase schedule information, with the commodity information which the customer terminal 2 has read. The customer terminal 2 determines whether or not the commodity corresponding to the read commodity identification information is a commodity included in the purchase schedule information, based on this comparison result. When the customer terminal 2 determines that the commodity corresponding to the read commodity identification information is the commodity included in the purchase schedule information, the customer terminal 2 displays an icon added with a character string such as “THIS IS PURCHASE SCHEDULED COMMODITY”, as a message. Accordingly, the customer can judge whether or not to purchase the commodity, by adding the information that the commodity corresponding to the commodity identification information read by the customer terminal 2 is the purchase scheduled commodity.

In addition, when the customer terminal 2 reads the commodity identification information of the commodity included in the purchase schedule information, the customer terminal 2 acquires additional information stored in the shopping list management table T2 of the center server 3, corresponding to the commodity which corresponds to the read commodity identification information. The customer terminal 2 may make the display 23 display this acquired additional information, in such a manner that the customer can identify it. Specifically, the customer terminal 2 makes the display 23 display the information indicating that discount is performed, an electronic coupon instructing to impart privilege, and the advertisement information to advertise a specific store and commodity, as the additional information. Accordingly, the customer can judge whether or not to purchase the commodity, by adding the additional information.

The program executed in each of the devices of the shopping support system according to the first embodiment is previously installed in a storage medium (ROM or storage unit) provided in each of the devices. However, the method of providing the above-described program to each of the above-described devices is not limited. For example, the program may be provided to each of the above-described devices, by recording the program in a computer readable recording medium, such as a CD-ROM, a flexible disk (FD), a CD-R, a DVD (Digital Versatile Disk), in a file of an installable format or an executable format. In addition, the above-described storage medium is not limited to a medium independent from a computer or an incorporation system, but a recording medium is included which stores or temporarily stores the program, by downloading the program communicated from a LAN, Internet or the like.

The program executed in each of the devices of the above-described embodiment may be stored in a computer connected to a network such as Internet, and the program may be provided to the shopping support system, by being downloaded from this computer via the network. Furthermore, the above-described program may be provided or distributed to the shopping support system, via a network such as Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shopping support device comprising:
a communication unit to communicate with an electronic shelf tag on which a price of a commodity is displayed, so as to read identification information of the displayed commodity from the electronic shelf tag;
a storage unit to store the identification information and commodity information of the commodity corresponding to each other;
a display to display the commodity information stored in the storage unit; and
a controller which acquires the commodity information of the commodity corresponding to the identification information that is read using the communication unit, makes the storage unit store the acquired commodity information corresponding to the identification information, and makes the display display the commodity information stored in the storage unit.

2. The shopping support device according to claim 1, wherein the controller has a shopping support processor to acquire the commodity information.

3. The shopping support device according to claim 2, wherein the shopping support processor acquires the commodity information of the commodity corresponding to the identification information from an external server.

4. The shopping support device according to claim 2, wherein the shopping support processor acquires the commodity information of the commodity corresponding to the identification information from the electronic shelf tag.

5. The shopping support device according to claim 2, wherein the controller has a history creation processor which makes the storage unit store that the controller has made the display display the commodity information, as reference information.

6. The shopping support device according to claim 5, wherein the commodity information includes traceability information of the commodity.

7. The shopping support device according to claim 6, wherein the display displays the traceability information of the commodity, as the commodity information.

8. The shopping support device according to claim 7, wherein the display displays a first operator to accept an operation by a customer so as to make the commodity information to be displayed.

9. The shopping support device according to claim 8, wherein the commodity information includes a recipe of a cuisine which uses the commodity of the commodity information.

10. The shopping support device according to claim 9, wherein the display displays the recipe of the cuisine, as the commodity information.

11. The shopping support device according to claim 10, wherein the display has a second operator to accept an operation by the customer so as to make the recipe of the cuisine to be displayed.

12. The shopping support device according to claim 11, wherein the controller has a shopping list creation support processor which accepts an input of a candidate commodity that is a commodity of a purchase candidate of the customer, and stores the candidate commodity in the storage unit.

13. The shopping support device according to claim 12, wherein when the commodity of the identification information corresponds to the candidate commodity stored in the storage unit, the display displays the commodity information in such a manner that the customer can identify that the commodity displaying the commodity information is the candidate commodity.

14. A shopping support method comprising:
reading from an electronic shelf tag on which a price of a commodity is displayed, identification information of the displayed commodity;
acquiring commodity information of the commodity corresponding to the read identification information;
storing the acquired commodity information in a storage unit corresponding to the identification information; and
displaying the commodity information which is stored in the storage unit on a display.
